(19) United States
(12) Patent Application Publication
(10) Pub. No.: US 2026/0289857 A1
(43) Pub. Date: Sep. 24, 2026

(54) SYSTEM

(71) Applicant: SoftBank Group Corp., Tokyo (JP)

(72) Inventor: Miho MIYASHITA, Tokyo (JP)

(73) Assignee: SoftBank Group Corp., Tokyo (JP)

(21) Appl. No.: 19/565,625

(22) Filed: Mar. 13, 2026

(30) Foreign Application Priority Data
Mar. 19, 2025 (JP) 2025-045065

(51) Int. Cl. G06T 11/60; G06N 3/0475; H04L 51/02

(52) U.S. Cl. CPC G06T 11/60; G06N 3/0475; H04L 51/02

(57) ABSTRACT

A system includes a processor that is configured to receive, from a user, an input including dimensions and constituent elements for a visual representation, generate, based on the received input, a prompt sentence for instructing a generative AI model to generate the visual representation, and obtain, by using the generated prompt sentence, the visual representation from the generative AI model and cause the obtained visual representation to be displayed on a terminal of the user.

### CROSS-REFERENCE TO RELATED APPLICATION

This application is based on and claims priority under 35 USC 119 from Japanese Patent Application No. 2025-045065 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional systems for creating visual representations such as banners or other graphic materials, a user is required to manually design, edit, and iteratively refine visual layouts, colors, texts, and other constituent elements. This manual process is time-consuming, requires specialized design skills, and makes it difficult for non-expert users to efficiently obtain high-quality visual representations. Furthermore, even when generative AI models are available, a user generally needs to manually craft and adjust prompts in order to obtain desired visual outputs, and must repeatedly experiment with different prompts to improve the quality and performance of the generated content. In addition, conventional systems do not sufficiently utilize user interaction data, such as selection operations or selection rates, to automatically optimize prompts or constituent elements of the visual representations. As a result, it is difficult to automatically and continuously improve visual representations based on actual user preferences or performance indicators. Therefore, there is a need for a system that can automatically generate prompts for a generative AI model based on user-specified dimensions and constituent elements, obtain visual representations from the model, and further adjust and regenerate such visual representations in response to measured selection rates, thereby reducing user burden and improving the effectiveness of the generated visual representations.

### SUMMARY

In order to solve the above-described problems, according to one aspect of the present invention, there is provided a system comprising a processor, wherein the processor is configured to receive, from a user, an input including dimensions and constituent elements for a visual representation, generate, based on the received input, a prompt sentence for instructing a generative AI model to generate the visual representation, and obtain, by using the generated prompt sentence, the visual representation from the generative AI model and cause the obtained visual representation to be displayed on a terminal of the user. The processor is further configured to monitor selection operations performed by the user with respect to the visual representation, measure a selection rate based on the selection operations, and generate a new prompt sentence for automatically replacing the constituent elements of the visual representation based on the measured selection rate. The processor is also configured to adjust the prompt sentence so as to preferentially adopt constituent elements of a visual representation having a high selection rate, and instruct the generative AI model to regenerate the visual representation based on the adjusted prompt sentence. By automatically generating and adjusting prompt sentences in response to user inputs and measured selection rates, the system reduces the need for manual design and prompt engineering, and enables automatic optimization of visual representations according to user preferences and performance data.

The term “system” refers to an arrangement of one or more hardware and software components, including at least a processor, that cooperatively perform the functions described in the present specification.

The term “processor” refers to any hardware or combination of hardware and software capable of executing instructions, performing logical and arithmetic operations, and controlling other components of the system, including but not limited to a CPU, GPU, ASIC, FPGA, or a plurality thereof.
The term “user” refers to any human operator or entity that interacts with the system, including by providing inputs such as dimensions and constituent elements, viewing visual representations, or performing selection operations.
The term “terminal” refers to any device or apparatus operated by or accessible to the user, and capable of sending inputs to the system and displaying outputs from the system, including but not limited to a personal computer, smartphone, tablet, or web browser.
The term “input” refers to information provided from the user to the system, including but not limited to dimensions, constituent elements, and any other parameters used to generate or modify a visual representation.
The term “dimensions” refers to size-related parameters of a visual representation, including but not limited to width, height, aspect ratio, resolution, or any combination thereof.
The term “constituent elements” refers to individual components that make up a visual representation, including but not limited to text, images, colors, shapes, layouts, fonts, or any other graphical or content elements.
The term “visual representation” refers to any image, graphic, banner, advertisement, or other visually perceivable content generated, obtained, or displayed by the system based on the user's input and the output of the generative AI model.
The term “prompt sentence” refers to a textual or structured instruction generated by the processor and provided to a generative AI model, the instruction specifying conditions, constraints, or descriptions for generating a visual representation.
The term “generative AI model” refers to a machine learning model, such as a neural network or other data-driven model, that is capable of generating new content, including visual representations, in response to an input prompt sentence.
The term “obtain the visual representation from the generative AI model” refers to causing the generative AI model to execute a generation process based on a prompt sentence and receiving, from the generative AI model, data representing the generated visual representation.
The term “cause the obtained visual representation to be displayed” refers to outputting or transmitting data representing the visual representation to the terminal in a format suitable for rendering on a display device, such that the user is able to visually perceive the representation.
The term “selection operation” refers to any operation performed by the user to indicate a preference or choice with respect to one or more visual representations, including but not limited to clicking, tapping, selecting, or otherwise interacting with a displayed visual representation.
The term “selection rate” refers to a metric representing how frequently a visual representation or a constituent element is selected by users, including but not limited to a ratio of the number of selection operations to the number of display events or impressions within a predetermined period or dataset.
The term “new prompt sentence” refers to a prompt sentence generated by the processor after initial visual representations have been displayed and user selection data has been collected, the new prompt sentence being intended to modify or replace constituent elements of subsequent visual representations.
The term “automatically replacing the constituent elements” refers to modifying a configuration of a visual representation by the processor without requiring manual editing by the user, such that one or more constituent elements are added, removed, or substituted based on predefined rules, measured selection rates, or both.
The term “adjust the prompt sentence” refers to changing content of a prompt sentence, including but not limited to modifying wording, adding constraints, specifying particular constituent elements, or altering parameter values, so as to influence the output of the generative AI model.
The term “preferentially adopt constituent elements” refers to selecting or weighting certain constituent elements with higher priority or frequency compared to other elements, based on criteria such as higher selection rate or better performance metrics.
The term “regenerate the visual representation” refers to causing the generative AI model to generate a new visual representation, or an updated version of a previous visual representation, based on an adjusted or new prompt sentence.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

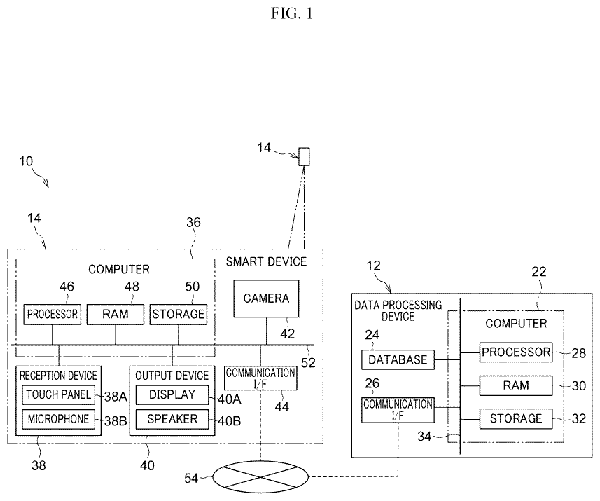

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

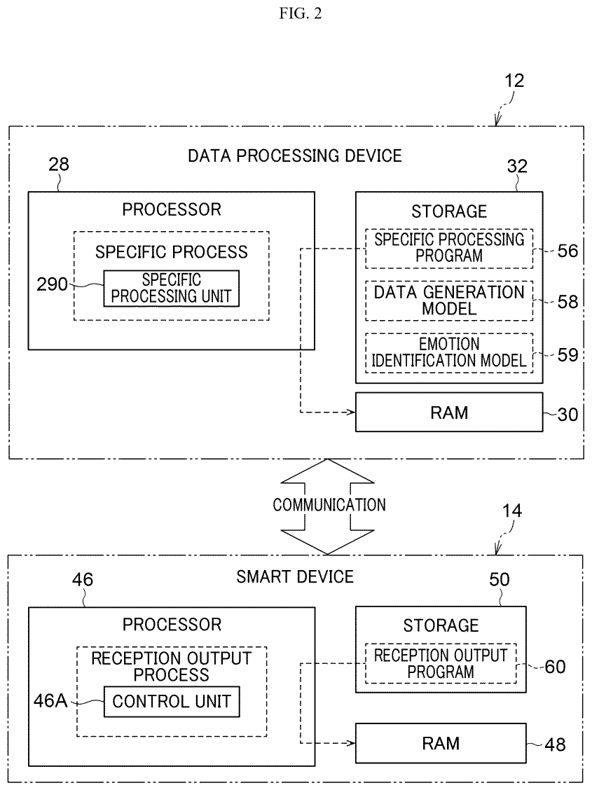

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional techniques for creating and optimizing visual representations, such as digital images and banners, suffer from several technical limitations when implemented on general-purpose computing environments. In typical systems, a user manually specifies design parameters through a graphical user interface, and a design application or content creation tool running on a client device or server generates or edits images according to those parameters. This approach imposes a heavy processing and interaction burden on the client device and the user, because the client must repeatedly render preview images, and the user must manually iterate over design variations. As a result, overall system latency increases, bandwidth is inefficiently consumed by transferring large image assets for trial-and-error design, and server-side resources are not effectively leveraged to coordinate data-driven optimization across multiple design iterations.

Moreover, when generative AI models are used, conventional systems typically accept a free-form natural-language prompt directly from the user and then request an image from a remote AI service. Such systems do not systematically structure the prompt based on machine-readable attribute information, do not persistently associate prompts with generated images, and do not exploit user interaction data to automatically refine subsequent prompts. Consequently, the generative AI model is not efficiently guided toward high-quality outputs for a given application context, and the computational resources of the server and AI model are underutilized or wasted by generating many suboptimal images that the user must manually sort through.
In addition, known systems generally lack a unified mechanism on the server to measure user selection behavior across multiple generated visual representations and to feed such behavioral metrics back into the prompt-generation logic. Without such a feedback loop, the computing system cannot programmatically learn which design configurations are preferred in practice, cannot adjust prompt sentences to emphasize high-performing components, and cannot automatically converge to more effective visual representations. This leads to increased processing time, redundant computation on generative AI hardware, and excessive client-server round-trips caused by repeated manual design adjustments.
Accordingly, there is a need for a computer-implemented technique that improves the functioning of server-side components and generative AI model interfaces by: (i) automatically converting structured attribute information received from a user terminal into optimized prompt sentences; (ii) centrally generating, storing, and distributing visual representations from a server using a generative AI model; and (iii) monitoring user selection behavior to compute selection rates and automatically refine prompt sentences over time. By addressing these issues, the computing system can reduce unnecessary network traffic, lower latency perceived by the user, and utilize processing resources of servers and AI accelerators more efficiently, thereby improving the overall performance and technical capabilities of computer systems that generate and optimize visual representations.

The specific processing by the specific processing unit 290 of the data processing device 12 in Example 1 is realized by the following means.

The present invention provides a server comprising a processor and a storage device, the processor being configured to receive, via a communication interface from a user terminal, attribute information including size information and configuration information for a visual representation, automatically convert the attribute information into a structured prompt sentence expressed as a natural-language instruction that describes generation conditions for the visual representation, transmit the prompt sentence together with associated image generation parameters to a generative AI model via a communication network, receive from the generative AI model image data of a visual representation generated based on the prompt sentence, store the image data and supplementary metadata, including the prompt sentence and user-related context, in the storage device, and transmit the image data or reference information to the user terminal for display. This enables the server to centrally control prompt construction and image generation, thereby reducing client-side processing overhead, improving network efficiency, and providing a consistent, machine-readable association between prompt sentences and generated visual outputs.

The present invention further provides that the processor is configured to monitor selection operation information transmitted from the user terminal indicating user interactions with multiple generated visual representations, calculate a selection rate for each visual representation based on a number of selection events and a number of presentation events, and, based on the calculated selection rates, automatically generate new prompt sentences that modify configuration information of the visual representations and supply those new prompt sentences to the generative AI model to request additional candidate images. This enables the server to implement a feedback-driven optimization loop at the system level, where user interaction data is transformed into refined prompt sentences, improving the relevance of subsequent generations while optimizing the utilization of generative AI computation resources.
The present invention still further provides that the processor is configured to identify configuration information associated with visual representations whose selection rates satisfy a predetermined condition, adjust subsequent prompt sentences so that such configuration information is emphasized as high-priority generation conditions within the prompt sentences, and retransmit the adjusted prompt sentences to the generative AI model to trigger regeneration of visual representations that reflect the high-performing configuration information. This enables the computing system to automatically converge toward more effective visual designs over time through programmatic prompt sentence refinement, thereby improving the technical performance of the generative pipeline, reducing redundant image generation operations, and enhancing the responsiveness and scalability of the overall server-based visual representation generation system.

The term “processor” refers to a hardware arithmetic and logic unit, such as a central processing unit or graphics processing unit, configured to execute instructions of a program and perform data processing operations to implement the functions described in the system. The term “storage device” refers to a non-transitory computer-readable medium, such as a semiconductor memory, magnetic storage, or optical storage, configured to store data, programs, prompt sentences, image data, and metadata used in the system.

The term “communication interface” refers to a hardware and software subsystem, such as a network adapter and associated protocol stack, configured to send and receive data between the server and external devices over a communication network.
The term “communication network” refers to a wired or wireless data communication infrastructure, such as a local area network, wide area network, or the Internet, that enables data exchange between the server, the user terminal, and a generative AI model.
The term “user terminal” refers to an electronic device, such as a personal computer, tablet, or smartphone, having a display apparatus and an input apparatus, configured to present user interfaces and transmit user input and selection operations to the server.
The term “display apparatus” refers to a hardware output device, such as a liquid crystal display, organic EL display, or other electronic display, configured to visually present the visual representation to a user.
The term “attribute information” refers to structured data specifying characteristics of a visual representation, including at least size information and configuration information, which is input by a user through the user terminal.
The term “size information” refers to information indicating a spatial extent of a visual representation, such as width, height, resolution, or aspect ratio expressed in units including pixels or other dimensional units.
The term “configuration information” refers to information specifying design elements of a visual representation, such as colors, text content, fonts, layout, graphics, and other components that define the appearance of the visual representation.
The term “visual representation” refers to a digital content item, such as an image, banner, or graphical layout, that is generated by the generative AI model and displayed on the display apparatus of the user terminal.
The term “prompt sentence” refers to a text string expressed in a natural language that describes generation conditions for a visual representation, including at least size information and configuration information, and that is provided as input to the generative AI model.
The term “model input information” refers to data provided to a generative AI model, including at least one prompt sentence and may further include image generation parameters such as size, format, and number of outputs.
The term “image generation parameters” refers to control values specifying conditions for image creation by the generative AI model, such as output size, image format, number of images to generate, or generation quality settings.
The term “generative AI model” refers to a machine learning model, such as a neural network-based generative model, configured to generate image data or other content based on a prompt sentence and associated model input information.
The term “image data” refers to digital data representing a visual representation, such as raster pixel data encoded in formats including PNG, JPEG, or other image formats.
The term “reference information” refers to data that specifies a location or identifier of image data, such as a file path, uniform resource locator, or content identifier, which can be used by the user terminal to retrieve and display the visual representation.
The term “supplementary information” refers to metadata associated with a visual representation, including at least the corresponding prompt sentence, timestamps, user identifiers, selection metrics, or other contextual information stored by the server.
The term “selection operation information” refers to data indicating user interactions with one or more visual representations, such as clicks, taps, confirmations, or other input events that express user selection or non-selection.
The term “selection rate” refers to a numerical value calculated for a visual representation based on at least a number of selection events and a number of presentation events, representing a relative frequency with which the visual representation is selected.
The term “presentation event” refers to an occurrence in which a visual representation is transmitted to and rendered on a user terminal for potential viewing by a user.
The term “selection event” refers to an occurrence in which a user performs a specified operation, such as pressing a button or interacting with a control, indicating that the user has selected or approved a particular visual representation.
The term “high-priority generation conditions” refers to conditions within a prompt sentence that are emphasized or weighted by the processor, based on selection rate or other metrics, so as to more strongly influence the output of the generative AI model.
The term “predetermined condition” refers to a criterion or threshold, such as a minimum selection rate or ranking position, which is specified in advance and used by the processor to determine whether configuration information of a visual representation is to be treated as high priority.
The term “regeneration” refers to a process in which the generative AI model generates one or more additional visual representations based on an adjusted prompt sentence that has been modified in view of previous generation results or selection data.
The term “user-related context” refers to information associated with the user or the usage environment, such as user identifiers, session identifiers, device types, or application contexts, which is stored together with prompt sentences and image data.
The term “log information” refers to recorded data about operations executed by the server, including the creation, transmission, and adjustment of prompt sentences, the responses from the generative AI model, and the reception of user interactions.
The term “feedback-driven optimization loop” refers to a sequence of processing steps in which user interaction data, including selection rates, is collected, analyzed, and used to adjust prompt sentences for subsequent requests to the generative AI model, thereby iteratively improving generated visual representations.

In one embodiment, a server executes a program on a hardware platform that includes at least one central processing unit (CPU), a main memory, a non-transitory storage device, and a network interface. The server optionally includes at least one graphics processing unit (GPU) or tensor processing unit (TPU) dedicated to acceleration of a generative AI model. The server runs an operating system such as a general-purpose server operating system, and middleware such as a web server and an application framework. The server uses specific software components, for example a web server (such as an HTTP server), an application framework (such as a server-side scripting framework), and a machine learning framework (such as a tensor computation library) to implement the described functions.

A terminal is an electronic apparatus such as a smartphone, tablet, or personal computer. The terminal includes a display apparatus, an input apparatus (for example, a touchscreen, keyboard, or pointing device), a network interface, and a processor. The terminal runs a web browser or native application that communicates with the server over a communication network such as the Internet. A user operates the terminal to access a web-based interface provided by the server.
The server stores a generative AI model in the storage device. In one embodiment, the generative AI model is implemented as a diffusion-based image generation network using a machine learning framework such as a tensor computation library. The generative AI model includes a text encoder network and an image generator network. The text encoder network is implemented as a transformer-based neural network that converts a prompt sentence in natural language into a fixed-length or sequence text embedding. The image generator network is implemented as a U-Net style convolutional neural network with skip connections and attention layers, trained to iteratively denoise a latent representation of an image conditioned on the text embedding.
The server trains the generative AI model in advance using a large dataset of image-text pairs stored in the storage device. The server initializes model parameters of the text encoder and the image generator network and iteratively updates the parameters by minimizing a loss function. The server selects a loss function such as a combination of a mean squared error term on noise prediction and a cross-entropy term on text-image alignment. The server performs stochastic gradient descent or an adaptive optimizer such as Adam to update the model weights based on gradients computed by backpropagation. The server optionally performs data augmentation operations, such as random cropping, resizing, color jittering, and text paraphrasing, to improve generalization of the model. The server periodically stores updated model parameters in the storage device.
In operation, the server receives attribute information from the terminal. The terminal sends the attribute information as structured data over the communication network. The server parses the received data and holds size information, such as width and height in pixels, and configuration information, such as background color, foreground color, text strings, font attributes, layout style, and optional graphic elements. The server represents this information in internal data structures, for example associative arrays or records stored in the main memory.
The server converts the attribute information into a prompt sentence expressed in natural language. The server uses a prompt-construction module that formats the values of the size information and the configuration information into predefined linguistic templates. The server concatenates phrases in a predetermined order to create a prompt sentence that is easily interpretable by the text encoder network. For example, the server generates prompt sentences such as:
“Please generate a 300×250 pixel visual display. Use a red background and display the text ‘On Sale!’ in white.”
“Please generate a 1080×1920 pixel visual display. Use a dark blue gradient background, place the title text ‘Winter Sale’ in large white letters at the top, and add smaller yellow text ‘Up to 50% OFF’ at the bottom.”
“Please generate a 728×90 pixel banner. Use a light green background, show a shopping cart icon on the left, and display the text ‘Free Shipping Today’in bold black letters on the right.”
   The server stores each generated prompt sentence in the storage device together with identifiers for the user, the terminal, and the corresponding attribute information, as metadata. This explicit data structure, which ties structured attribute fields to a text prompt used for generation, allows the server to later reconstruct the relationship between user input, prompt sentence, and output image.
   The server transmits the prompt sentence and associated image generation parameters to the generative AI model. In one embodiment, the server invokes a local model by passing the prompt sentence as input to the text encoder network and specifying parameters such as target resolution, output format, and number of samples. The server uses the CPU to schedule computations and uses the GPU to execute tensor operations, including matrix multiplications and convolutions. The text encoder network converts the prompt sentence into a numerical embedding vector. The image generator network uses this text embedding as a condition and performs a sequence of denoising steps in a latent space. At each step, the network predicts noise components based on the current latent and the text embedding, and the server numerically integrates a diffusion process or reverse diffusion process by applying the predicted noise and a schedule of variance parameters. The server finally decodes the latent into pixel space and outputs image data.
   In another embodiment, the server transmits the prompt sentence and generation parameters to an external generative AI service over the communication network. The server sends an API request including the prompt sentence, size, and output format; the external service runs a similarly structured generative AI model and returns image data. The server then treats the returned data in the same way as locally generated data.
   The server receives image data of the generated visual representation and writes it to the storage device, for example as a file in an image directory or as an object in a binary large object store. The server also records the associated prompt sentence and supplementary information such as timestamps, user identifiers, terminal type, and generation parameters. By structuring the storage so that each image is linked to its prompt and context, the server enables later analysis and optimization of the generative process.
   The server transmits the image data or a reference to the image data, such as a uniform resource locator, to the terminal. The terminal receives this information and causes the display apparatus to present the visual representation. The terminal may also display user interface controls allowing the user to accept or reject the generated visual representation. The user performs one or more operations, such as selecting a “use” button or a “regenerate” button. The terminal captures these interactions as selection operation information and sends them back to the server.
   The server monitors the selection operation information to compute a selection rate for each generated visual representation. The server increments a presentation counter every time a specific visual representation is displayed on a terminal and increments a selection counter when the user performs a selection operation indicating approval or preference. The server periodically computes a selection rate as the ratio between the selection counter and the presentation counter for each visual representation or for each configuration pattern. The server stores these counters and selection rates in a database table indexed by image identifiers, prompt identifiers, or configuration patterns.
   The server analyzes the selection rate data to identify configuration information that contributes to higher user preference. The server applies algorithms such as statistical ranking, bandit algorithms, or reinforcement-learning-style selection to determine which colors, text formulations, layout arrangements, or size patterns are associated with higher selection rates. For example, the server may represent each configuration component as a feature and learn feature weights that correlate with higher selection rates using a logistic regression model or a simple neural network. The server uses this learned relation when constructing new prompt sentences.
   The server generates new prompt sentences that modify the configuration information based on the computed selection rates. When the server detects that the selection rate for a particular visual representation or component falls below a predetermined threshold, the server alters one or more configuration elements. For example, the server may change the background color, adjust text length, reorder elements, or add decorative graphics. The server incorporates these changes into a new prompt sentence while preserving constraints such as required text content or fixed size. The new prompt sentence may, for instance, emphasize alternative color schemes or layouts that previous high-performing prompts have used. The server sends these new prompt sentences to the generative AI model to generate different candidate visual representations.
   The server further adjusts prompt sentences to emphasize configuration information extracted from visual representations with selection rates above a predetermined condition. The server identifies patterns in the configuration information, such as a particular color combination or font style, that consistently yield higher selection rates. The server encodes these patterns as high-priority generation conditions within the prompt sentence by adding explicit instructions, adjectives, or constraints. For example, the server may modify a prompt sentence to say “Use a bright red background and large bold white text that clearly stands out” if such characteristics align with components observed in high-selection-rate images.
   The server then reuses these adjusted prompt sentences for regenerations, which shifts the generative AI model's output distribution toward configurations more likely to be preferred. The system thereby provides a feedback-driven optimization loop that is implemented entirely in terms of specific data structures, algorithms, and model interactions executed by the server and the generative AI model. The server does not merely automate human design decisions, but instead exploits the generative AI model's high-dimensional representation space and selection-rate-driven feedback to explore and converge on effective design regions in a manner that would be impractical or impossible for manual operation.
   This architecture yields several technical effects. The server reduces computational overhead on the terminal by centralizing intensive image generation on hardware that includes GPUs and optimized libraries. The server reduces network load by sending compact attribute information and prompt sentences, instead of repeated raw image edits, and by selectively regenerating only when selection-rate-based criteria are not met. The server improves latency by structuring prompts in a form that the generative AI model can process efficiently, leading to higher-quality outputs with fewer iterations. The server improves data management by persistently associating prompt sentences, attribute information, generated image data, and selection-rate metrics in a normalized database schema, enabling efficient indexing, querying, and analysis.
   The generative AI model itself operates according to rules that differ from traditional rule-based design tools. Instead of directly applying fixed templates, the model uses learned latent representations derived from training data and mathematically defined loss functions. During training, the server computes gradients of the loss function with respect to model weights, performs mini-batch optimization, and uses techniques such as learning rate scheduling, weight decay, and gradient clipping to stabilize training. During inference, the model follows a specific denoising schedule, such as a series of time steps with predefined or learned noise variances, and uses the text embedding as a conditioning signal on cross-attention layers inside the U-Net to enforce semantic alignment between the prompt sentence and the generated image. The server controls these internal processes by passing precise configuration parameters and by managing random seeds where reproducibility is required.
   The server implements the described functionality in a modular architecture. A communication module handles network requests and responses. A parsing and validation module converts incoming structured attribute information into internal representations and performs range checks and type validation. A prompt construction module generates prompt sentences based on preconfigured templates and learned weighting of configuration components. A model interface module prepares model input information, invokes the generative AI model either locally or remotely, and obtains output tensors. An image post-processing module converts tensors into encoded image files and stores them in the storage device. A logging and analytics module records prompt sentences, user interactions, and selection-rate metrics. A control module orchestrates these modules according to predefined logic and selection-rate-driven policies.
   The system can be implemented in various alternative configurations. In one variation, the server hosts multiple different generative AI models, such as diffusion models and autoregressive transformer-based image models, and selects a model depending on size constraints or content type. In another variation, the server runs part of the prompt construction or ranking logic on the terminal for offline or low-latency operation, while still centralizing generative AI computation on the server. In yet another variation, the server continuously updates a lightweight recommendation model that maps attribute information to adjusted prompt sentence parameters based on newly acquired selection-rate data, enabling on-line learning without retraining the full generative AI model.
   In all of these embodiments, the server uses concrete hardware resources, defined data structures, and specific algorithmic steps to transform structured attribute information and user interaction signals into optimized prompt sentences and generated visual representations. The resulting system improves the functioning of the underlying computer technology by enhancing image generation efficiency, reducing redundant computation and communication, and enabling data-driven optimization of generative AI outputs that goes beyond mere automation of human design tasks.

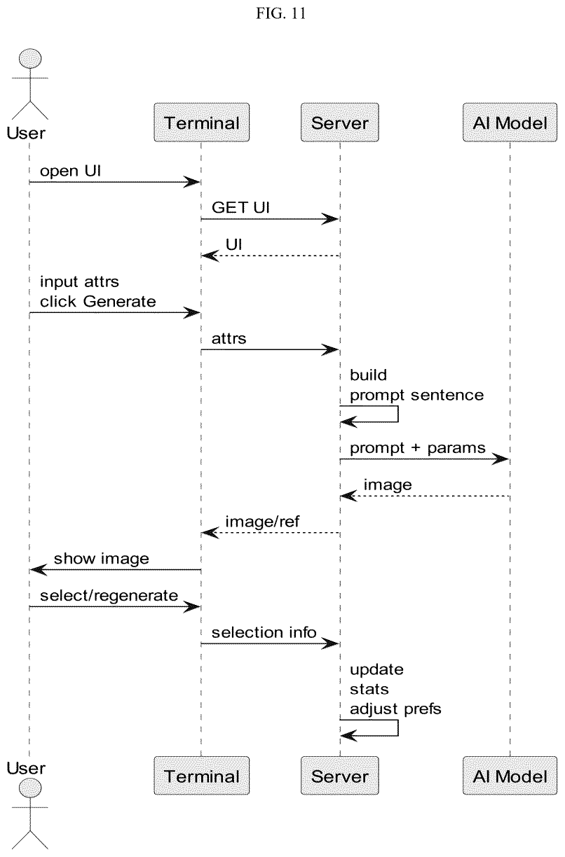

The following describes the processing flow using FIG. 11.

### Step 1:

The user operates the terminal to launch a web browser or native application and accesses a URL or endpoint provided by the server. The terminal sends an HTTP request to the server and receives an HTML, CSS, and JavaScript interface.
Input: User interaction (URL entry or app launch) and HTTP response from the server.
Output: A rendered user interface on the terminal that includes input fields for size information and configuration information of a visual representation.
The terminal executes the received JavaScript to construct form elements (for example, text boxes, dropdowns, and color pickers) and displays them on the display apparatus for user input.

### Step 2:

The user views the interface on the terminal and inputs attribute information including size information (for example, width and height in pixels) and configuration information (for example, background color, text content, text color, and layout). The user then operates a “Generate” button or equivalent control.
Input: Visual form rendered on the terminal and user operations on the input fields and button.
Output: A structured set of attribute values stored in the terminal's memory (for example, a key-value map) ready to be transmitted to the server.
The terminal executes client-side logic that reads values from the form fields, validates formats (for example, checking numeric ranges for width and height), and prepares a structured data object representing the attribute information.

### Step 3:

The terminal transmits the attribute information to the server via the communication network.
Input: Structured attribute information held in the terminal's memory.
Output: An HTTP or HTTPS request containing the attribute information in a structured format (for example, JSON) sent to the server.
The terminal uses a networking API to serialize the attribute information into a request body, sets headers such as content type, and sends the request to a predefined API endpoint on the server.

### Step 4:

The server receives the request containing the attribute information and parses the request.
Input: An HTTP or HTTPS request with a body containing size information and configuration information.
Output: Internal data structures (for example, objects or records) stored in the server's main memory representing the parsed attribute information.
The server uses a web server component to accept the network connection, passes the request to an application framework, and invokes a JSON or body parser that reads the request body and converts it into in-memory variables holding width, height, colors, text strings, and layout descriptors.

### Step 5:

The server validates the attribute information and, if valid, prepares it for prompt generation.
Input: Parsed attribute information stored in internal data structures.
Output: A validated attribute object; in the case of invalid input, an error response to the terminal.
The server executes validation logic that checks numeric ranges, allowed color values, and mandatory fields. Based on this logic, the server either constructs an error message and returns it to the terminal, or proceeds by storing the validated attribute information in temporary memory for further processing.

### Step 6:

The server generates a prompt sentence by combining the attribute information with predefined linguistic templates.
Input: Validated attribute information including size information and configuration information.
Output: A prompt sentence expressed in natural language describing generation conditions for the visual representation.
The server calls a prompt-construction module that concatenates text fragments. For example, the server converts width and height into a phrase like “300×250 pixel visual display” and converts configuration information into phrases like “Use a red background and display the text ‘On Sale!’ in white.” The server then joins these phrases to form a complete prompt sentence such as:
“Please generate a 300×250 pixel visual display. Use a red background and display the text ‘On Sale!’in white.”
The server stores this prompt sentence in memory and optionally in the storage device with an identifier.

### Step 7:

The server prepares model input information for the generative AI model.
Input: The generated prompt sentence and the validated attribute information.
Output: A model input structure including the prompt sentence and image generation parameters (for example, target width, height, and output format).
The server constructs a data structure that includes the prompt sentence as text and numerical parameters such as image dimensions and desired number of images. The server may map text fields into configuration flags for the model interface module.

### Step 8:

The server invokes the generative AI model using the model input information.
Input: Model input structure containing the prompt sentence and image generation parameters.
Output: A request to a local or remote generative AI model and, after processing, an AI model response containing generated image data.
The server either calls a local model API, passing the prompt and parameters to a text encoder and image generator, or sends a network request to an external service. The server manages the call, waits for completion, and receives the result, which is typically a tensor representing image pixels or encoded image bytes.

### Step 9:

The server processes the output of the generative AI model to obtain final image data.
Input: Raw model output such as an image tensor or encoded image bytes.
Output: An encoded image file (for example, PNG or JPEG) suitable for storage and transmission.
The server uses an image-processing library to convert a tensor into a raster image and then encodes it into a standard format. The server writes the encoded image to the storage device and associates it with the corresponding prompt sentence and attribute information by recording metadata in a database or index.

### Step 10:

The server returns the generated visual representation to the terminal.
Input: Encoded image data and associated reference information stored on the server.
Output: A response message to the terminal containing the image data itself or a reference such as a URL.
The server constructs an HTTP or HTTPS response that includes either the image in an appropriate format or data that allows the terminal to retrieve and display the image (for example, a path or URL). The server sets appropriate headers and status codes and sends the response through the network interface.

### Step 11:

The terminal receives the response from the server and displays the generated visual representation.
Input: Response from the server containing image data or reference information.
Output: A rendered visual representation on the display apparatus and updated user interface elements around the image.
The terminal parses the response, updates the document object model (DOM) or native UI components to include an image element whose source is the received image or URL, and instructs the graphics subsystem to draw the image on the screen. The terminal also displays interactive controls such as “Use this design” and “Regenerate.”

### Step 12:

The user evaluates the displayed visual representation and performs a selection or non-selection operation.
Input: The rendered visual representation and UI controls displayed on the terminal.
Output: A user action, such as clicking a selection button or a regenerate button, captured as an event by the terminal.
The user observes the appearance of the image and decides whether it is acceptable.
Depending on the decision, the user selects an appropriate control; the terminal then records which control was activated and prepares corresponding selection operation information.

### Step 13:

The terminal transmits selection operation information to the server.
Input: Event data representing the user's selection or non-selection operation.
Output: An HTTP or HTTPS request containing selection operation information for a specific visual representation.
The terminal extracts identifiers associated with the displayed image and the prompt, attaches a flag indicating selection or rejection, and sends this data as a structured message to a dedicated endpoint on the server.

### Step 14:

The server updates selection statistics based on the received selection operation information.
Input: Selection operation information from the terminal, including image identifiers and operation type.
Output: Updated counters in a storage device representing presentation counts, selection counts, and selection rates for each visual representation or configuration pattern.
The server retrieves the existing counters from a database, increments the presentation count if the image was shown, increments the selection count if the user selected the image, and recomputes the selection rate as a ratio or other metric. The server writes the updated counters back into persistent storage.

### Step 15:

The server analyzes accumulated selection rates to identify high-performing configuration information.
Input: Selection rates, counters, and associated configuration information stored in the storage device.
Output: A set of configuration features and weights or rankings indicating which elements are preferred.
The server applies an analysis algorithm that reads configuration attributes and their corresponding selection statistics, and computes feature importance or preference scores. For example, the server may calculate which background colors correlate with higher selection rates or which text phrasing leads to more selections. The server stores these results as learned parameters in a configuration preference model.

### Step 16:

The server generates new or adjusted prompt sentences reflecting the analysis results.
Input: Newly requested attribute information from the terminal and the preference model or selection-based parameters.
Output: New or adjusted prompt sentences that preserve required constraints but modify or emphasize configuration elements predicted to perform better.
The server uses the preference model to alter template selection, wording, or ordering of instructions in the prompt sentence. For example, the server may change a prompt to say “Use a bright red background and large bold white text that clearly stands out” when red backgrounds and bold fonts have shown high selection rates. The server then stores these adjusted prompt sentences and uses them as input for further invocations of the generative AI model, re-entering the flow from Step 7 for subsequent generations.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented systems for generating visual content using a generative AI model typically treat the model as a black-box image generator that receives an unstructured text instruction and outputs a static image. Such systems often rely on manual trial-and-error by human operators, who repeatedly craft and adjust natural language prompts to obtain a desired visual result. As a consequence, the quality, consistency, and efficiency of visual content generation are highly dependent on the individual operator's skill in prompt engineering rather than on systematic computational control.

Furthermore, conventional systems generally do not maintain a structured representation of user requirements, such as dimensional constraints, background conditions, text elements, and image elements, in a machine-consumable format that is tightly coordinated with the prompt sentence. The absence of explicit, normalized structured information makes it difficult for the computer to reliably transform user inputs into prompts that are optimized for the generative AI model, and to derive reproducible, predictable behavior from the model across multiple generations.
In addition, many existing systems provide limited support for interactive, iterative refinement of generated visual content. When a user edits or partially approves a generated visual output, conventional architectures typically do not feed this editing information back into the prompt construction logic in a structured manner. As a result, the computer system fails to leverage user edits to automatically update structured constraints and regenerate improved visual outputs, thereby requiring users to manually re-specify complex instructions. Moreover, selection behavior of users, such as which visuals are chosen or preferred among multiple candidates, is not systematically captured as machine-usable feedback to adjust the generative AI model's inputs. Traditional systems rarely compute selection-based evaluation values or use them to algorithmically modify prompt sentences. Consequently, the computer is not effectively utilizing user interaction data to improve subsequent prompt generation, prioritize effective visual elements, or optimize the generative process over time.
Accordingly, there is a need for improvements to computer technology that enable a processor to: (i) normalize user inputs into structured information, (ii) automatically generate and update prompt sentences based on that structured information, (iii) integrate generative AI outputs with additional image processing under explicit dimensional and compositional constraints, and (iv) algorithmically exploit user editing operations and selection behavior to refine prompt sentences and direct the generative AI model. Such improvements would enhance the computer's ability to control and optimize the pipeline from user input to final visual output, thereby reducing dependence on manual prompt engineering and increasing the technical efficiency and reliability of the system.

The specific processing by the specific processing unit 290 of the data processing device 12 in Application Example 1 is realized by the following means.

The present invention provides a server comprising a processor and a storage device, the processor being configured to acquire user input including dimension information and configuration information from a user terminal and convert the user input into normalized structured information conforming to a predetermined format; generate, based on the structured information, a prompt sentence in a natural language including at least a dimension condition, a background condition, text information, and image information, and convert the prompt sentence into model input information adapted to a generative AI model; execute the generative AI model using the model input information to obtain a generation result including visual output information corresponding to the prompt sentence; perform, based on the generation result, a compositing process and a text rendering process on the visual output information by using an image processing function to generate visual display information having a predetermined dimension; store the visual display information and attribute information corresponding to the prompt sentence in the storage device and transmit the visual display information to the user terminal for display; acquire editing operation information from the user terminal, update the structured information and the prompt sentence based on the editing operation information, and cause the generative AI model to perform regeneration by using the updated prompt sentence; monitor selection operations for a plurality of pieces of visual display information on the user terminal, calculate a selection evaluation value based on the selection operations, automatically modify a description content and priority of the configuration information in the prompt sentence according to the selection evaluation value to generate a new prompt sentence, and cause the generative AI model to execute regeneration based on the new prompt sentence. This enables the computer system to systematically transform user inputs into optimized prompt sentences, to tightly couple structured constraints with generative AI processing and post-processing, and to algorithmically exploit user edits and selection feedback to improve subsequent generations of visual content, thereby enhancing the technical performance, controllability, and efficiency of AI-based visual content generation.

The term “user input” refers to information provided by a human operator through a user terminal, including at least dimensional constraints and configuration conditions for visual content.

The term “dimension information” refers to data representing a size constraint of visual content, including at least a width and a height expressed in units such as pixels or other display-related units.
The term “configuration information” refers to data representing compositional elements of visual content, including at least background conditions, text elements, and image elements to be included in the visual content.
The term “structured information” refers to user input that has been converted into a machine-readable and normalized format, such as a data structure or record including explicitly defined fields for respective elements of the user input.
The term “normalized structured information” refers to structured information that has been adjusted to conform to a predetermined schema or format, including standardized ranges, data types, and representations for dimension information and configuration information.
The term “prompt sentence” refers to a natural language expression that describes requirements for generating visual content, including at least dimension conditions, background conditions, text information, and image information, and that is used as a basis for input to a generative AI model.
The term “dimension condition” refers to a constraint described in the prompt sentence that specifies the required size or aspect ratio of visual content.
The term “background condition” refers to a constraint described in the prompt sentence that specifies background-related attributes of visual content, including at least color, pattern, or style of a background region.
The term “text information” refers to data representing character strings to be rendered in visual content, including at least main messages, titles, or other textual elements.
The term “image information” refers to data representing one or more graphical elements to be included in visual content, including at least bitmap images, vector graphics, icons, or logo images.
The term “model input information” refers to data derived from the prompt sentence and formatted for use by a generative AI model, including at least tokenized or encoded representations of the prompt sentence and optional additional conditioning data.
The term “generative AI model” refers to a machine learning model trained to generate content outputs, including at least an image or other visual representation, based on input data such as a prompt sentence or encoded conditioning information.
The term “generation result” refers to an output produced by the generative AI model in response to the model input information, including at least visual output information suitable for further processing.
The term “visual output information” refers to data representing raw or intermediate visual content produced by the generative AI model, typically in the form of multi-dimensional numerical arrays corresponding to pixel values or feature maps.
The term “image processing function” refers to a computational function or module that performs operations on visual output information, including at least compositing, resizing, color adjustment, and text rendering.
The term “compositing process” refers to an operation that combines multiple visual elements, including at least background regions, text layers, and image layers, into unified visual content.
The term “text rendering process” refers to an operation that draws or overlays text information onto visual content by selecting fonts, sizes, positions, and styles and converting character strings into graphical representations.
The term “visual display information” refers to visual content that has been processed into a final or display-ready form, including at least a bitmap image or similar representation having predetermined dimensions suitable for presentation on a display device.
The term “attribute information” refers to metadata associated with visual display information or a prompt sentence, including at least identifiers, timestamps, configuration parameters, and evaluation values related to the generation or use of the visual display information.
The term “storage device” refers to a hardware or virtual storage resource that stores data persistently or semi-persistently, including at least non-volatile memory, magnetic storage, or network-based storage.
The term “user terminal” refers to an electronic device operated by a user and configured to send user input to the server, display visual content, and provide interaction capabilities, including at least a smartphone, tablet, or personal computer.
The term “editing operation information” refers to data representing modifications specified by a user with respect to visual content, including at least changes in text, colors, positions, sizes, or inclusion and exclusion of elements.
The term “regeneration” refers to a process in which the generative AI model is executed again based on updated or modified prompt sentences or conditioning information to produce new or revised visual output information.
The term “selection operation” refers to a user interaction indicating a preference or choice among multiple pieces of visual display information, including at least clicks, taps, or explicit selection commands.
The term “selection evaluation value” refers to a quantitative indicator derived from one or more selection operations, representing a degree of user preference or effectiveness of a corresponding piece of visual display information.
The term “priority of the configuration information” refers to a relative weighting or ordering assigned to elements of configuration information, which influences how strongly or prominently those elements are expressed in the prompt sentence or reflected in generated visual content.
The term “description content of the prompt sentence” refers to specific textual expressions used in the prompt sentence, including the wording, level of detail, and explicitness of dimension conditions, background conditions, text information, and image information.
The term “description order of the prompt sentence” refers to an arrangement of clauses or segments in the prompt sentence, including the sequence in which different conditions or pieces of information are presented to the generative AI model.

In one embodiment, a server cooperates with one or more terminals operated by a user to generate and optimize visual display information using a generative AI model controlled by structured constraints and dynamically updated prompt sentences.

The server comprises at least one processor, a memory, a storage device, and a network interface. The server executes an application program, for example implemented using a general-purpose programming language such as Python and a web application framework such as a web server gateway framework, and uses a machine learning library such as a tensor computation library to implement and execute the generative AI model. The server further uses an image processing library such as a bitmap manipulation library for compositing, color adjustment, and text rendering.
The terminal comprises a processor, a display, an input device, and a communication module. The terminal executes an application, for example a native mobile application or a browser-based client, that provides a graphical user interface including input fields for dimension information, configuration information, and editing operations. The terminal communicates with the server over a network using a communication protocol such as HTTPS.
The user operates the terminal to specify requirements for a visual advertisement or other visual content. The user inputs dimension information, such as width and height of the visual content in pixels, and configuration information such as background color, main text, and one or more images to be included. The terminal converts these raw inputs into an internal data structure, for example a record containing fields for width, height, background color, primary text string, and references to image files stored on the terminal.
The server acquires the user input from the terminal through a programmatic interface exposed by the server. The server converts the user input into normalized structured information. The server converts textual color names into numeric color values in a color space such as RGB, converts width and height into integer values in pixels, and validates that the specified values fall within permitted ranges. The server stores the normalized structured information in the memory as a data structure with fixed fields and canonical formats, which allows deterministic processing in subsequent modules.
The server generates a prompt sentence in a natural language based on the structured information. The server uses a prompt generation module implemented as a deterministic string-construction algorithm. The server reads the structured information fields and inserts them into a template in a fixed order. For example, when the user specifies a width of 300 pixels, a height of 250 pixels, a blue background, main text “New product now on sale”, and a logo image, the server generates the following prompt sentence:
“Generate a 300×250 pixel visual advertisement with a blue background. The main text should be ‘New product now on sale’. Use the specified logo image placed prominently.”
   The server thereby ensures that each structured field has a corresponding phrase or clause in the prompt sentence, and that important constraints such as dimensional information appear in a predetermined position in the prompt sentence. This deterministic mapping from structured information to textual clauses improves reproducibility and reduces variability compared to manual prompt creation by a human user.
   The server converts the prompt sentence into model input information suitable for the generative AI model. The server uses a tokenizer associated with the generative AI model to convert the prompt sentence into a sequence of token identifiers. The server packs these identifiers into numerical tensors, pads them to a fixed length, and inserts special tokens representing field boundaries. The server optionally creates separate conditioning vectors representing dimension information and background color by scaling the numeric values into a normalized range and concatenating them to the text-based conditioning vector. As a result, the generative AI model receives a structured combination of linguistic conditioning and numeric constraints.
   The server implements the generative AI model as a deep neural network. In one embodiment, the generative AI model is a diffusion-based image generation model having a text encoder and an image decoder. The server uses a neural network library to define the text encoder as a transformer architecture including multiple self-attention layers, multi-head attention mechanisms, and feed-forward layers. The server encodes the tokenized prompt sentence into a text embedding vector using this text encoder. The server then feeds the text embedding vector into a U-Net-based denoising network that operates in a latent image space. The server iteratively updates a latent tensor representing an image by applying convolutional layers, normalization layers, and attention layers conditioned on the text embedding. The server uses a predefined noise schedule and a sampling algorithm, such as a numerical solver for stochastic differential equations, to gradually denoise an initial noise tensor into a structured image representation.
   The server decodes the latent image representation into pixel-level visual output information. The server uses a decoder network consisting of upsampling and convolution layers to map the latent tensor to an RGB image tensor. The server crops or resizes the image tensor to exactly match the specified width and height in the structured information. The server thereby enforces the dimensional constraints at a numerical level inside the image generation pipeline, rather than relying solely on post-hoc resizing.
   The server performs an image compositing process using an image processing library. The server loads the logo image and other image elements referenced in the configuration information. The server resamples these images as needed to match the target resolution and applies alpha compositing to place them at specific positions such as a bottom-right region. The server then executes a text rendering process to overlay the main text onto the image. The server selects a font, font size, and text positioning according to rules associated with the structured information. For example, if the text length exceeds a threshold, the server automatically adjusts line breaks and font size to maintain legibility within the given dimensions. The server computes precise pixel coordinates for each glyph and writes corresponding pixel values into the target image buffer.
   The server thus generates visual display information in a final, display-ready format such as a bitmap image encoded in a compressed file format. The server stores this visual display information in the storage device and associates it with attribute information. The attribute information includes at least the prompt sentence, the structured information, a timestamp, and identifiers for the user and the design session. The server generates a reference, such as a uniform resource identifier, that can be used by the terminal to retrieve and display the generated visual content.
   The terminal receives the reference or the actual image data from the server and displays the visual display information on the screen. The user views the generated visual and uses editing tools on the terminal to request modifications. The user may change the text, select a different background color, move the logo, or request a different visual style. The terminal converts these editing operations into editing operation information, represented as changes to the structured information. For example, when the user drags the logo on the screen, the terminal computes new coordinates and sends these updated coordinates to the server.
   The server acquires the editing operation information from the terminal and updates the structured information accordingly. The server then generates an updated prompt sentence. For example, when the user changes the text and logo position, the server may generate:
“Generate a 300×250 pixel visual advertisement with a blue background. The main text should be ‘Limited-time new product now on sale’. Place the logo in the bottom-right corner.”
   The server repeats the process of tokenization, conditioning, generative inference, and image post-processing using the updated prompt sentence and structured information. By reusing the structured information as a stable intermediate representation, the server can maintain certain constraints, such as dimensions and color ranges, while altering only selected aspects such as textual content and element positions. This architecture improves computational efficiency because the server can selectively reuse cached embeddings or partial computations when only a subset of fields changes.
   The server further improves the generation process by monitoring selection operations across multiple visual display information instances. The user may be presented with multiple candidate visuals, and the user selects one by touching or clicking on the desired image on the terminal. The terminal transmits selection identifiers to the server. The server calculates a selection evaluation value for each candidate by applying a scoring function to the selection events, such as a weighted count of selections over time. The server then analyzes correlations between high selection evaluation values and underlying configuration information, such as color schemes, text lengths, or logo placements.
   The server automatically modifies the description content and ordering of the prompt sentence based on these selection evaluation values. For example, when visuals with a particular background color and concise text receive higher selection evaluation values, the server adjusts priority weights assigned to these attributes in the structured information. The server then increases the emphasis on corresponding clauses in future prompt sentences, or reorders the clauses so that preferred properties appear earlier in the prompt sentence. By explicitly encoding these adjustments in the deterministic prompt generation logic, the server systematically incorporates user preference data into the generative pipeline, rather than relying on ad hoc human prompt modifications.
   The server in one embodiment uses a rule-based adjustment module that modifies a set of numerical weights associated with each configuration field. The server stores these weights in the storage device and updates them based on the selection evaluation values using a mathematical update rule such as exponential moving averaging. The server maps higher weights to stronger or more explicit wording in the prompt sentence, for example by adding reinforcement phrases or constraining modifiers. This structured feedback process improves the alignment between generated visuals and user preferences, while maintaining deterministic behavior beneficial for repeatability and testing.
   The generative AI model itself is trained in advance using a large corpus of image and text pairs. The server, during a training phase, uses a dataset containing images and associated captions, augmented by synthetic examples that encode dimension and layout constraints. The server initializes the neural network parameters randomly or from a pre-trained model. The server uses a loss function such as a denoising objective in the diffusion model framework, combined with auxiliary losses on text-image alignment. The server computes gradients of the loss function with respect to the model parameters using automatic differentiation and updates the parameters using an optimization algorithm such as stochastic gradient descent with adaptive moment estimation. The server or a separate training system applies data augmentation techniques such as random cropping, color jittering, and text paraphrasing to increase robustness and improve generalization of the model. By configuring the model to accept explicit numeric dimensions and structured conditioning inputs, the server enables more accurate control over output resolution and layout than conventional models that rely only on unstructured text prompts.
   The system thereby provides technical improvements over traditional manual prompt engineering and ad hoc image post-processing. The server's use of normalized structured information and deterministic prompt generation improves computational predictability, enabling reproducible outputs under the same inputs. The server's integration of explicit numeric constraints into the generative AI model input improves dimensional accuracy and reduces the need for costly post-hoc scaling. The server's structured feedback loop, in which selection evaluation values and editing operation information are algorithmically incorporated into prompt sentence adjustment and prioritization, enables the computer to refine its generative behavior over time using quantitative metrics instead of manual trial-and-error.
   The combination of these mechanisms reduces wasted computation by decreasing the number of unsuccessful or unacceptable generations, reduces network traffic by limiting the number of candidate images that must be transmitted to the terminal, and improves storage efficiency by enabling the system to curtail retention of low-performing alternatives. Because the server implements a specific architecture for data flows, including structured information, prompt sentences, model input tensors, visual output tensors, and selection evaluation values, the system achieves measurable technical effects such as faster convergence to acceptable visual designs, improved alignment between generated images and specified constraints, and lower variance in output quality.
   The terminal in another embodiment performs part of the prompt generation and structured information normalization locally, and the server focuses on model execution and post-processing. In yet another embodiment, the generative AI model is deployed in a distributed fashion across multiple processing nodes, with the prompt encoder executing on a first node and the image decoder executing on a second node. The system can also employ alternative neural network architectures, such as generative adversarial networks or autoregressive image generators, provided that the server maintains the mapping from structured information and prompt sentences to model input tensors, and preserves the feedback-loop mechanisms described above.
   In all of these embodiments, the server, the terminal, and the user cooperatively perform operations that go beyond simple automation of human mental steps. The server implements specific data structures, numerical processing flows, and learning-based adjustment mechanisms that improve the operation of the computer system itself in generating, managing, and optimizing visual display information conditioned on structured requirements and dynamically refined prompt sentences.

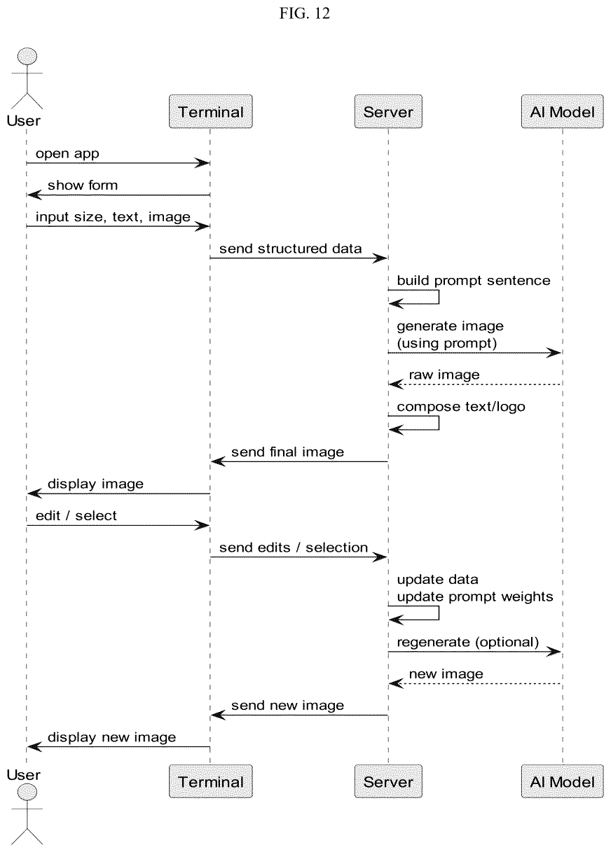

The following describes the processing flow using FIG. 12.

### Step 1:

The user operates the terminal to launch an application for generating visual content. The input in this step is a user action such as tapping an application icon or navigating to a web page. The terminal loads user interface components, allocates memory for session data, and initializes default values for dimension information and configuration information. The output of this step is an active application screen that displays input fields for width, height, background color, text, and image selection.

### Step 2:

The user inputs initial requirements for a visual representation through the terminal. The input in this step is user-provided dimension information (for example, width and height in pixels) and configuration information (for example, background color, main text, and image selection). The terminal captures keystrokes and selection events, converts them into internal variables, and performs basic validation such as checking that width and height are positive integers and that the selected image file exists. The output of this step is validated raw input data stored temporarily in the terminal's memory.

### Step 3:

The terminal transforms the validated raw input data into structured information. The input in this step is the set of raw values for width, height, color, text, and selected image references. The terminal normalizes the data by converting named colors into numeric color values, trimming whitespace from text strings, and converting file paths into standardized identifiers. The terminal then encapsulates these normalized values into a structured record with predefined fields, such as a JSON-like object with keys for dimension information and configuration information. The output of this step is normalized structured information that can be transmitted to the server.

### Step 4:

The terminal transmits the structured information to the server. The input in this step is the structured information record created in Step 3. The terminal serializes the structured information into a format such as a JSON body, attaches any selected image files as multipart data, and opens a secure network connection to the server using a communication protocol such as HTTPS. The terminal then sends the request message containing both the structured information and the image data. The output of this step is a network request received by the server that contains all the necessary user constraints for generating visual content.

### Step 5:

The server receives and parses the network request. The input in this step is the HTTP request containing structured information and optional image files. The server uses a network interface to accept the request, then uses a request-parsing module to decode the JSON body and extract each field, such as width, height, background color, and text. The server stores uploaded image files in a temporary directory and records their paths. The server validates the structured information again on the server side, checking type correctness and value ranges. The output of this step is a validated and server-side structured data object, including references to any stored image files.

### Step 6:

The server constructs a prompt sentence based on the structured information. The input in this step is the validated structured data object containing dimension information and configuration information. The server executes a deterministic prompt generation routine that maps each field to a textual clause. The server then concatenates these clauses in a predetermined order to form one coherent natural-language instruction. For example, given a width of 300 pixels, a height of 250 pixels, a blue background, text “New product now on sale”, and a logo image, the server generates the following prompt sentence: “Generate a 300×250 pixel visual advertisement with a blue background. The main text should be ‘New product now on sale’. Use the specified logo image placed prominently.” The output of this step is a complete prompt sentence corresponding to the structured information.

### Step 7:

The server converts the prompt sentence and auxiliary constraints into model input information for the generative AI model. The input in this step is the prompt sentence generated in Step 6, combined with numeric constraints such as width, height, and color values. The server uses a tokenizer to split the prompt sentence into tokens and map each token to an integer identifier, creating a sequence of token IDs. The server then creates one or more numerical tensors from these IDs, pads them to a fixed length, and adds special markers to indicate boundaries between clauses. The server also encodes numeric constraints into separate tensors by scaling the dimension values into a normalized range and representing colors in a color space. The output of this step is a set of tensors that collectively constitute the model input information for the generative AI model.

### Step 8:

The server executes the generative AI model to produce a latent visual representation. The input in this step is the model input information from Step 7, including token embeddings and numeric constraint embeddings. The server feeds the token embeddings into a text encoder network, such as a transformer, to compute a text embedding vector. The server then injects this text embedding into a diffusion-based generative network that iteratively transforms an initial noise tensor into a structured latent image tensor. During each iteration, the server performs tensor operations such as convolution, attention, normalization, and nonlinear activation on the latent tensor, guided by the text embedding and dimension-related conditioning. The output of this step is a latent image representation encoded as a multi-dimensional tensor in a latent feature space.

### Step 9:

The server decodes the latent image representation into pixel-level visual output information. The input in this step is the latent image tensor generated in Step 8. The server uses a decoder module, such as an upsampling convolutional network, to transform the latent tensor into an RGB tensor whose dimensions correspond to pixel rows, pixel columns, and color channels. The server checks the resulting tensor's dimensions and, if necessary, performs interpolation or cropping operations to align the tensor with the requested width and height. The output of this step is a raw visual output tensor that directly represents pixel values for the generated image.

### Step 10:

The server performs compositing and text rendering to integrate configuration elements into the raw visual output. The input in this step is the visual output tensor from Step 9, together with references to image elements (for example, logo files) and text information from the structured data. The server converts the visual output tensor into an image object and loads the external image elements from storage. The server resizes the external images as needed, calculates placement coordinates (for example, the bottom-right corner), and composites the external images onto the output image using alpha blending operations. The server then computes the layout for the main text, selects an appropriate font and size, and renders each character string onto the image by drawing pixels at calculated positions. The output of this step is a fully composed image that satisfies the specified dimensions and incorporates the background, text, and image elements described by the user.

### Step 11:

The server stores the generated visual display information and its associated attribute information. The input in this step is the fully composed image from Step 10 and the structured information that describes its generation context. The server encodes the image into a file format such as PNG or JPEG and writes the file to a storage device. The server then creates a record in a database or metadata store, associating the stored image file with attributes such as the prompt sentence, the dimension and configuration information, timestamps, and a session identifier. The output of this step is a stored visual display file and a corresponding metadata record that can be retrieved in later interactions.

### Step 12:

The server transmits the generated visual display information to the terminal for presentation. The input in this step is the stored image file or a reference to it, along with any metadata that should be sent to the terminal. The server constructs a response message that includes either the image data itself or a content locator that the terminal can use to fetch the image. The server sends this response over the network using a protocol such as HTTPS. The output of this step is a network response that delivers the generated visual content and associated information back to the terminal.

### Step 13:

The terminal receives and displays the visual display information to the user. The input in this step is the server's response message containing image data or an image locator. The terminal parses the response, downloads the image if a locator is provided, and decodes the image into a bitmap. The terminal then renders the bitmap on the display using its graphics subsystem, placing it in a designated area of the application interface. The output of this step is a rendered visual representation visible to the user on the terminal screen.

### Step 14:

The user performs editing operations on the displayed visual content via the terminal. The input in this step is the visual display information rendered on the terminal and the user's interactions with the interface, such as text edits, color changes, or dragging of image elements. The terminal captures these interactions as editing commands, converts them into updated values for dimension information and configuration information, and updates its local structured data accordingly. The output of this step is editing operation information that reflects the user's modifications to the original constraints.

### Step 15:

The terminal transmits the editing operation information to the server for regeneration. The input in this step is the updated structured information resulting from the user's edits. The terminal packages the updated fields into a new request message and sends it to the server through the network, similar to the transmission in Step 4. The output of this step is a regeneration request received by the server, indicating that new visual content should be generated based on the modified constraints.

### Step 16:

The server updates the structured information and generates an updated prompt sentence. The input in this step is the editing operation information and the previous structured data stored in the server. The server merges the new values with the previous structured information, preserving unchanged fields and replacing modified ones. The server then runs the prompt generation routine again to produce a new prompt sentence that reflects the user's edits. For example, if the user changes the main text and logo position, the new prompt sentence may be: “Generate a 300×250 pixel visual advertisement with a blue background. The main text should be ‘Limited-time new product now on sale’. Place the logo in the bottom-right corner.” The output of this step is an updated structured data object and a corresponding updated prompt sentence.

### Step 17:

The server regenerates visual content based on the updated prompt sentence and structured information. The input in this step is the updated prompt sentence and the associated constraints. The server repeats the process described in Steps 7 through 10: converting the prompt sentence into model input information, executing the generative AI model to produce a latent representation, decoding the latent representation to a pixel-level tensor, and applying compositing and text rendering. The server may reuse cached intermediate embeddings or configuration mappings to reduce computation when only a subset of constraints changes. The output of this step is a revised visual display image that reflects the user's edits while maintaining other constraints such as dimensions.

### Step 18:

The user selects preferred visual display information among multiple alternatives, and the system uses this feedback to refine future generations. The input in this step is a set of candidate images displayed on the terminal and the user's selection actions, such as clicking on one of the images. The terminal transmits identifiers of the selected images to the server. The server computes selection evaluation values for each candidate, updates priority weights assigned to various configuration elements based on these metrics, and stores these updated weights. In subsequent prompt generation operations, the server uses these weights to adjust the description content and order in the prompt sentences, emphasizing attributes that correspond to higher selection evaluation values. The output of this step is an updated set of weighting parameters and an improved prompt generation policy that leads to visual outputs more closely aligned with observed user preferences.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional systems for generating visual content using a generative AI model based on a prompt sentence, the role of the computer is largely limited to passively forwarding user inputs to the model and returning generated images. The computer system typically does not perform structured, machine-driven optimization of the generated visual content based on actual user interaction metrics, such as impression counts and selection counts. As a result, the generative AI model is repeatedly invoked with similar or ad hoc prompt sentences, without effective use of historical performance data of visual components, such as button color, text style, layout pattern, or background color. This leads to several technical problems in the operation of the computer system itself.

First, the processor and storage device in such conventional systems do not maintain or exploit fine-grained, component-level performance data. The system may log which image was selected, but it does not systematically decompose each visual display data into constituent components, aggregate selection performance per component, and feed this information back into subsequent generation parameters. Therefore, the generative AI model is not guided by structured, performance-aware parameters, and the computing resources (processor cycles, memory bandwidth, and network bandwidth) are consumed to generate many suboptimal visual display data whose effectiveness is unknown or poorly utilized.
Second, conventional systems do not provide an automated mechanism in the processor for reconfiguring prompt sentences and generation parameters based on measured selection rates. The adjustment of prompt sentences is often done manually by a human operator, which is slow, subjective, and not scalable. The absence of a computer-implemented feedback loop that automatically rewrites prompt sentences and updates default generation parameters causes the generative AI model to produce outputs that do not converge toward higher-performing designs, thereby reducing the overall efficiency of the computing system and increasing redundant calls to the generative AI model.
Third, the computer architecture in the conventional approach lacks an integrated control flow that links (i) user interaction on a terminal, (ii) server-side logging of impression and selection events, (iii) numerical computation of selection rates at both image and component levels, and (iv) automatic regeneration of visual display data emphasizing high-selection-rate components. Without such an integrated, processor-executed pipeline, the system cannot implement a data-driven, iterative optimization process. This results in unnecessary database operations, non-optimized use of storage, and ineffective utilization of network resources for delivering unoptimized visual display data to terminals.

Accordingly, there is a need for a computer-implemented technique in which a processor systematically acquires user interaction data from a terminal, computes selection rates for each visual display data and for each component thereof, identifies high-selection-rate components, and automatically adjusts prompt sentences and generation parameters for the generative AI model. By implementing such a feedback loop at the processor level, the computer system can improve its internal processing efficiency, reduce redundant or low-value generations, and deliver visual display data that are optimized based on objective interaction metrics.

The specific processing by the specific processing unit 290 of the data processing device 12 in Example 2 is realized by the following means.

The present invention provides a server comprising a processor configured to receive, from a terminal operated by a user, attribute information including dimension information and component information, and a prompt sentence for use with a generative AI model; generate, based on the attribute information, generation parameters including the prompt sentence, image size information, color attribute information, and layout attribute information, and input the generation parameters to the generative AI model to cause the generative AI model to generate a plurality of visual display data; store, in a storage device, the plurality of visual display data acquired from the generative AI model and identification information corresponding to each of the plurality of visual display data, and manage the identification information in association with the attribute information; transmit the visual display data stored in the storage device to the terminal and cause the terminal to present the visual display data; acquire, from the terminal, operation information relating to numbers of times of display and numbers of times of selection for each of the plurality of visual display data in accordance with the presentation on the terminal, and record the numbers of times of display and the numbers of times of selection in association with the identification information; calculate, based on the numbers of times of display and the numbers of times of selection, selection rates for each of the plurality of visual display data and for each component constituting the plurality of visual display data; aggregate the selection rates for each component to identify high-selection-rate components; automatically adjust the prompt sentence and the generation parameters such that the identified high-selection-rate components are preferentially included, and input the adjusted prompt sentence and adjusted generation parameters to the generative AI model to cause the generative AI model to regenerate new visual display data; and transmit the new visual display data reflecting the high-selection-rate components to the terminal and cause the terminal to present the new visual display data. This enables the computer system to implement, in an automated and data-driven manner, a feedback loop in which the processor continuously optimizes generation parameters and prompt sentences based on measured selection rates, thereby improving the efficiency of model invocation, reducing redundant generation of low-performing visual display data, and enhancing the overall performance and resource utilization of the underlying computing infrastructure.

The term “system” refers to a combination of hardware and software components including at least one processor, at least one storage device, and at least one communication interface, configured to execute the functions recited in the claims.

The term “processor” refers to a hardware computation unit, such as a central processing unit or other processing circuitry, configured to execute instructions to perform data processing operations described in the claims.
The term “server” refers to an information processing apparatus including the processor and associated memory and communication interfaces, configured to provide services to one or more terminals over a communication network.
The term “terminal” refers to an information processing apparatus operated by a user, such as a client device including an input interface and a display interface, configured to transmit data to and receive data from the server.
The term “user” refers to a human operator who interacts with the terminal to input information and to view and select visual display data.
The term “attribute information” refers to data specifying conditions or properties for generating visual display data, including at least dimension information and component information, and optionally including color information, layout information, and text information.
The term “dimension information” refers to data indicating size-related parameters of visual display data, such as width, height, aspect ratio, or resolution.
The term “component information” refers to data specifying individual elements that constitute visual display data, such as button attributes, text attributes, layout patterns, and background attributes.
The term “prompt sentence” refers to a text instruction input to a generative AI model, describing desired characteristics or content of visual display data to be generated.
The term “generative AI model” refers to a machine-learned model configured to generate data, such as image data, based on input including a prompt sentence and generation parameters.
The term “generation parameters” refers to control data provided to the generative AI model, including at least the prompt sentence, image size information, color attribute information, and layout attribute information, for specifying how visual display data are to be generated.
The term “image size information” refers to a subset of the generation parameters that defines a size of the visual display data, including at least width and height in pixels or another unit.
The term “color attribute information” refers to a subset of the generation parameters that defines one or more colors or color schemes to be used in the visual display data.
The term “layout attribute information” refers to a subset of the generation parameters that defines an arrangement relationship among components within the visual display data, such as positions of images, text, and buttons.
The term “visual display data” refers to data representing a visual content item, such as an image or a composite graphical object, suitable for presentation on a display device.
The term “storage device” refers to a memory apparatus, such as a non-volatile memory, a magnetic disk, or a solid-state drive, configured to store visual display data, attribute information, identification information, and operation information.
The term “identification information” refers to data that uniquely identifies each piece of visual display data or each record, enabling association among visual display data, attribute information, and operation information.
The term “operation information” refers to data indicating user interactions with visual display data on the terminal, including at least a number of times of display and a number of times of selection for each visual display data.
The term “number of times of display” refers to a count value representing how many times a specific visual display data has been presented on one or more terminals.
The term “number of times of selection” refers to a count value representing how many times a specific visual display data has been selected or activated by a user via the terminal.
The term “selection rate” refers to a metric representing a ratio or other quantitative relationship between the number of times of selection and the number of times of display for visual display data or for a component thereof.
The term “component constituting the visual display data” refers to an individual element forming part of the visual display data, such as a button region, a text region, a graphic region, a layout region, or a background region.
The term “high-selection-rate components” refers to components constituting visual display data whose selection rates satisfy a predetermined condition, such as exceeding a threshold or ranking above other components.
The term “aggregate” refers to the operation of computing a statistical value, such as a sum, an average, or a distribution, of selection rates across multiple instances of components having a same or similar type.
The term “preferentially included” refers to a state in which high-selection-rate components are more likely to be used in generating new visual display data than other components, for example, by being set as default or by being assigned higher priority in the generation parameters.
The term “regenerate” refers to causing the generative AI model to newly generate visual display data based on adjusted prompt sentences and generation parameters that differ from those used in previous generations.
The term “template” refers to a pre-defined structure of a prompt sentence including fixed portions and variable portions, where component-related descriptions can be inserted, removed, or replaced automatically.
The term “optimized prompt sentence” refers to a prompt sentence generated by combining new attribute information with high-selection-rate components so as to improve expected performance of resulting visual display data.
In one embodiment, a server includes a processor, a main memory, a non-volatile storage device, and a network interface, and is connected via a communication network to one or more terminals operated by users. The server executes an operating system such as a general-purpose server operating system and one or more application programs implemented, for example, using a server-side framework and a database management system. The server cooperates with a generative AI model deployed either on the same hardware or on a separate inference apparatus connected via the network.
The terminal includes a processor, a display device, an input interface, a memory, and a communication interface. The terminal executes a browser application or a dedicated client application to display user interfaces provided by the server and to send user inputs to the server. The user operates the terminal to input attribute information and a prompt sentence, and to view and select visual display data.
The server uses the processor to execute a content generation application. The server application defines data structures for requests, generation parameters, visual display data, components, and interaction logs. For example, the server maintains in a storage device: a request table storing attribute information and prompt sentences per generation request; an image table storing references to generated visual display data and their identification information; a component table storing types of components such as button, text region, image region, and background; and an interaction log table storing impression counts and selection counts associated with each image and each component.
The server receives, via the network interface, attribute information from the terminal. The attribute information includes dimension information such as width and height in pixels; component information such as button region presence, headline text region presence, and image region position; and optional constraints such as preferred base color and layout type.
The server also receives a prompt sentence from the terminal. For example, the user inputs the following prompt sentence at the terminal:
“Please create a new product promotion banner. Use blue as the main color, place the product image on the left, and include discount information such as ‘20% OFF’on the right.”
   The server stores this attribute information and prompt sentence into the request table together with identification information and timestamps. The server uses the processor to transform the attribute information into generation parameters. For dimension information, the server converts human-readable dimensions into numeric width and height values. For color attributes, the server maps color names to numeric color codes (for example, RGB or HSV vectors) and color palettes. For layout attributes, the server maps layout names to discrete layout identifiers and, in some embodiments, to positional constraints (for example, normalized coordinates or grid positions) that are used either as conditioning tokens or as auxiliary feature channels for the generative AI model.
   The server uses a generative AI model implemented as a neural network, for example, a diffusion-based image generation model combined with a transformer-based text encoder. In one embodiment, the generative AI model includes: a text encoder module that tokenizes the prompt sentence, maps tokens to embeddings, and applies a multi-layer transformer network with self-attention and feed-forward blocks; and an image decoder module that implements a denoising diffusion process in a latent space. The server uses a machine learning library such as a tensor computation framework to execute the neural network on a graphics processing unit or other accelerator.
   The server pre-trains the generative AI model on a large corpus of paired text and image data. The server uses a loss function that measures a difference between predicted noise and actual noise in the diffusion process and uses gradient descent-based optimization to update weights. The server applies training techniques including learning rate scheduling, regularization, and data augmentation (such as random cropping, color jitter, and geometric transformations) to improve the robustness of the model. The server thus holds, in the storage device, a trained parameter set representing relationships between text prompts and visual features.
   The server uses the processor to encode the prompt sentence with the text encoder. The server constructs a conditioning vector by concatenating or combining the prompt embedding with vectors representing generation parameters such as size, color, and layout attributes. In one embodiment, the server normalizes each parameter to a fixed numeric range and uses a projection layer to map the parameters into the same embedding space as the prompt embeddings. This combined conditioning vector is then supplied to the diffusion model as a control signal, so that the denoising process produces images that respect both the textual content and the structured attributes.
   The server executes iterative diffusion steps, in each step applying convolutional blocks, attention mechanisms, and normalization layers to refine a noisy latent representation into a more detailed latent image. The server then applies a decoder network to convert the latent representation into a pixel-space image. The server generates multiple candidate images by sampling different random seeds or by modifying conditioning vectors within a range defined by the attribute information.
   The server stores the generated visual display data in the storage device. The server assigns each image an identification information value, such as a unique integer or a universally unique identifier. The server writes to the image table a record containing the image identifier, a file path or object storage location, the generation parameters used, and initial metrics such as impression count and selection count set to zero. The server also decomposes each image into logical components based on the generation parameters and predefined templates. For example, the server associates a region labeled as “call-to-action button” with a button color attribute, a region labeled as “headline text” with font size and color attributes, and so forth. The server stores these associations in the component table with references to the corresponding image identifiers.
   The server transmits references to the visual display data to the terminal. The terminal requests the image files via the network and displays them on the display device in a user interface that allows the user to select one or more images. The terminal sends back to the server interaction events whenever an image is displayed or selected. The terminal includes in each interaction event the relevant image identifier and a type of event (impression or selection).
   The server uses the processor to update impression counts and selection counts, which are stored in the interaction log table or as aggregate fields in the image table. For each impression event, the server increments the corresponding impression counter; for each selection event, the server increments the corresponding selection counter. The server periodically performs aggregation using a data processing module executed on the processor. The server calculates for each image a selection rate as the ratio of selection count to impression count, using numeric operations on integer or floating-point representations.
   The server also calculates component-level selection rates. The server maps each image to its components and propagates each impression and selection event to the components associated with that image. For each component type and specific component value (for example, “button color=red” or “layout pattern=text-left image-right”), the server sums the impression counts and selection counts across all images containing that component. The server then computes a selection rate per component value. The server stores these component-level statistics in a component statistics table, keyed by component type and component value.
   The server uses an optimization algorithm implemented by the processor to identify high-selection-rate components from the component statistics. In one embodiment, the server applies a threshold rule: if a component value's selection rate exceeds a predetermined threshold or exceeds an average selection rate across all values of that component type, the server marks the component value as a high-selection-rate component. In another embodiment, the server uses a multi-armed bandit algorithm, in which each component value is treated as an arm, and the server selects future component candidates based on an upper confidence bound or a Thompson sampling strategy. The server thereby reduces exploration of low-performing components and increases exploitation of high-performing components, which improves computational efficiency by focusing subsequent generation on promising design choices.
   The server updates default generation parameters used for subsequent requests. For example, if the server identifies “button color=red” as a high-selection-rate component, the server sets the default button color attribute to red in a parameter configuration table. If the server identifies “layout=text—left image—right” as high-performing, the server sets this layout as the default layout pattern unless overridden by a new user input. The server updates these defaults in persistent storage so that subsequent generation requests automatically benefit from the learned preferences without additional user intervention.
   The server manages prompt sentences as templates stored in the storage device. A template includes fixed text segments and variable placeholders for component descriptions, such as “[BACKGROUND_COLOR]”, “[BUTTON_COLOR]”, and “[LAYOUT_DESCRIPTION]”. The server uses the processor to automatically insert or replace these placeholders with descriptions corresponding to high-selection-rate components. For instance, if the server determines that a dark blue background and a bright red button yield a high selection rate, the server generates an optimized prompt sentence such as:
“Please create a new product promotion banner. Use a dark blue background, place the product image on the left, show ‘20% OFF’ on the right in large white bold text, and add a bright red ‘Buy Now’ button at the bottom center.”
   The server combines this optimized prompt sentence with new attribute information provided by the user to construct updated generation parameters. The server then re-invokes the generative AI model with these optimized parameters. Because the model receives a conditioning vector that encodes both the updated prompt sentence and the component preferences, the model produces new visual display data that embody the high-selection-rate components. This process changes the distribution of generated outputs in a data-driven manner and reduces the probability of generating low-performing combinations.
   The server thereby improves technical aspects of the computing system. By tracking component-level performance and adjusting generation parameters algorithmically, the server reduces the number of calls to the generative AI model that produce ineffective visual display data. This reduces computation time on the processor and accelerator, decreases memory bandwidth consumption during model inference, and lowers network traffic required to transmit redundant or low-value images to terminals. The server structures the data in normalized tables and uses indexed queries and aggregated fields to compute statistics efficiently, reducing disk I/O and CPU overhead. The feedback loop implemented in the server enables convergence toward a set of high-performing components, which improves the efficiency of the generative pipeline as a whole.
   In addition, the server employs specific machine learning techniques that are not equivalent to manual human tuning. The server uses a numeric optimization process that systematically evaluates components under varying conditions, and then encodes the results into updated parameter values and prompt templates. The server does not rely on subjective judgment but on objective metrics derived from interaction logs. The rules used by the server to adjust parameters, such as thresholding, bandit algorithms, or Bayesian optimization, form a set of non-conventional control procedures that directly modify how the model is conditioned. This control layer is implemented as executable instructions in memory and executed by the processor, providing a technical improvement over systems that simply pass user prompts through to a model without structured feedback.
   In another embodiment, the server executes the generative AI model on a separate inference apparatus connected via a high-speed network. The server packages generation parameters into a compact binary format, such as a serialized protocol format, to reduce communication overhead between the server and the inference apparatus. The server selects only a limited number of candidate parameter combinations, based on component-level statistics, before initiating inference requests. This selection reduces network traffic and computation on the inference apparatus, improving overall throughput. The server caches recently computed results and reuses them when equivalent or similar generation parameters are requested, further reducing redundant computation.
   In yet another embodiment, the server organizes the generation parameters and performance statistics in a hierarchical data structure. For example, the server maintains a tree where higher-level nodes represent layout classes and lower-level nodes represent specific combinations of color and text style. The server traverses this tree using a search algorithm that prioritizes branches with high historical selection rates. The server allocates computation resources preferentially to unexplored nodes that are close to high-performing branches, thereby implementing an informed search strategy in parameter space. This method improves search efficiency compared to naive random exploration, resulting in fewer inference runs and faster convergence toward effective visual configurations.
   The terminal and the server cooperate to realize a practical use case in which generated visual display data are used as banners or graphical elements in a real-world display system, such as a web site, an application interface, or a public display. Because the server optimizes images based on actual user selections recorded at the terminal, the system adapts to user preferences in a way that improves the relevance of displayed content while reducing the computational burden of generating many ineffective variants. The system thus provides a technical effect beyond automating a human designer's workflow, by reconfiguring how the computer hardware executes neural inference workloads, stores and organizes performance data, and controls communication flows.
   In still another embodiment, the server adjusts the internal parameters of the generative AI model itself. The server uses component-level performance statistics to fine-tune the model on a smaller training set constructed from high-performing images and their associated prompt sentences. The server uses a fine-tuning process with a loss function emphasizing conformity to high-selection-rate components. The server adjusts the model weights using gradient-based optimization on the accelerator, thereby shifting the model's prior distribution toward high-performing visual patterns. This further reduces the need to specify detailed constraints in generation parameters, because the model internalizes preferences at the parameter level. The server thus not only adjusts external conditioning parameters but also improves the internal representation of the generative AI model in a way that is guided by interaction data.
   Through these embodiments, the server, the terminal, and the user cooperate to implement a concrete, technical pipeline in which a generative AI model is integrated with structured logging, statistical analysis, and parameter optimization on a computing apparatus. The system improves the efficiency and effectiveness of computer-based image generation, enhances resource utilization, and produces visual display data that are dynamically adapted based on measurable performance, thereby providing a technical improvement in the field of computer-implemented content generation.

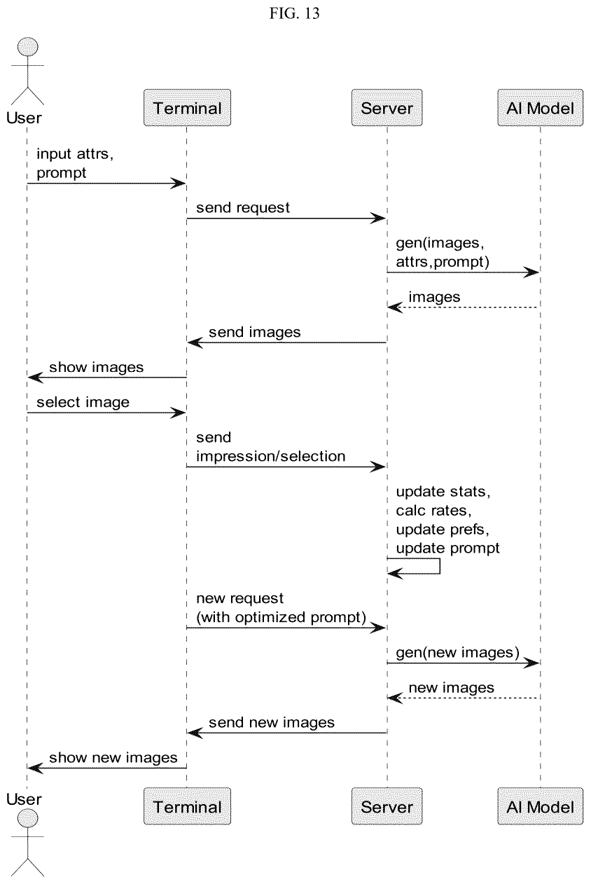

The following describes the processing flow using FIG. 13.

### Step 1:

The user operates the terminal to open an application screen provided by the server.
The terminal receives input from the user including attribute information (such as dimensions, colors, and layout types) and a prompt sentence describing desired visual display data.
The terminal uses its processor to assemble the input into a structured request object, performing simple validation (for example, checking that width and height are positive integers).
The terminal outputs the structured request object and transmits it to the server via a communication network using a request message.

### Step 2:

The server receives the request message from the terminal via a network interface.
The server uses its processor to parse the request message and extract the attribute information and the prompt sentence as input.
The server performs validation by checking data types, value ranges, and required fields, and converts human-readable values (for example, “blue,” “image_left_text_right”) into internal codes.
The server outputs normalized attribute data and a stored copy of the prompt sentence, and records them in a request record in a storage device together with identification information.

### Step 3:

The server uses the normalized attribute data as input to generate generation parameters for a generative AI model.
The server computes numeric values for the parameters, such as pixel width and height from the dimension information, color vectors from color names, and layout identifiers from layout names.
The server concatenates or merges these numeric values with the prompt sentence to construct a parameter set that includes both textual and structured information.
The server outputs a complete generation parameter set including the prompt sentence, image size information, color attribute information, and layout attribute information.

### Step 4:

The server uses the generation parameter set as input to invoke the generative AI model.
The server encodes the prompt sentence into token embeddings using a text encoder and maps the numeric parameters into embedding vectors using projection layers.
The server combines the embeddings and supplies them to a diffusion-based image generation network, which iteratively denoises latent representations using convolutional and attention layers under control of the conditioning vectors.
The server outputs one or more visual display data items, each represented as an image array in memory.

### Step 5:

The server receives the generated image arrays from the generative AI model as input.
The server uses its processor to compress or encode the image arrays into a suitable image format (for example, a raster format) and assigns identification information to each image.

The server writes file data to the storage device and records, in an image table, associations among image identifiers, storage locations, and the generation parameters used.
The server outputs stored image references (for example, file paths or object identifiers) corresponding to each generated visual display data item.

### Step 6:

The server uses the stored image references as input to prepare a response to the terminal.
The server constructs a response message that includes the identification information and the access locations of the visual display data.
The server transmits the response message to the terminal via the network interface.
The server outputs the response as a formatted data structure that the terminal can interpret to retrieve and display the images.

### Step 7:

The terminal receives the response from the server as input.
The terminal parses the response to obtain image identifiers and access locations, and then requests and downloads the image files from the server or a connected storage system.
The terminal decodes the image data and renders the visual display data on the display device, arranging them in a selectable user interface.
The terminal outputs a graphical display where each visual display data item is associated with its identifier and is ready for user interaction.

### Step 8:

The user views the visual display data presented on the terminal.
The user selects one or more preferred visual display data items by performing an input operation such as tapping or clicking on the corresponding display regions.
The terminal detects the selection events and uses the associated image identifiers as input for an interaction report.
The terminal outputs interaction messages containing the image identifiers, event types (impression or selection), and timestamps, and transmits them to the server.

### Step 9:

The server receives the interaction messages from the terminal as input.
The server extracts image identifiers and event types and updates impression counts and selection counts in an interaction log table or in aggregate fields of an image table.
The server increments the impression counter when an impression event is received and increments the selection counter when a selection event is received, using arithmetic operations on stored counters.
The server outputs updated statistical data for each visual display data item, including current counts and derived fields ready for later analysis.

### Step 10:

The server uses the updated statistical data as input to compute selection rates.
The server calculates, for each image identifier, a selection rate by performing a division operation of the selection count by the impression count, handling boundary conditions such as zero impressions.
The server writes the computed selection rates back into the image table and also maps each image to its components, accumulating impression and selection counts per component type and value.
The server outputs image-level and component-level selection rates stored in a component statistics structure.

### Step 11:

The server uses the component statistics as input to identify high-selection-rate components.
The server compares selection rates among component values of the same type using a rule such as threshold comparison or ranking, and marks components whose selection rates exceed a predetermined condition.
The server updates a configuration record or a component preference table to flag the identified components as high-selection-rate components and sets corresponding priority or weight values.
The server outputs an updated preference data set that specifies which component values should be prioritized in subsequent generations.

### Step 12:

The server uses the preference data set as input to adjust default generation parameters.
The server updates stored defaults for attributes such as button color, background color, and layout pattern to values corresponding to high-selection-rate components, replacing or re-weighting previous defaults.
The server modifies internal parameter templates so that, when new attribute information is missing or incomplete, the system fills in parameters using the updated defaults.
The server outputs revised default parameter settings that will be used as a basis for generating new generation parameter sets.

### Step 13:

The server uses prompt templates and the preference data set as input to construct an optimized prompt sentence.
The server inserts textual descriptions of high-selection-rate components into placeholder positions in the template, and combines them with fixed parts of the prompt.
The server, when receiving new attribute information from the user, merges that information with the component descriptions, producing a complete, optimized prompt sentence.
The server outputs the optimized prompt sentence ready to be included in a new generation parameter set.

### Step 14:

The user again operates the terminal to request further visual display data.
The terminal receives any newly specified attribute information from the user and, in some embodiments, receives from the server the optimized prompt sentence as input for display or confirmation.
The terminal assembles a new request including the optimized prompt sentence and either user-defined or default attribute values and transmits this request to the server.
The terminal outputs a new request message that triggers a new iteration of the generation process.

### Step 15:

The server receives the new request containing the optimized prompt sentence and updated attribute information as input.
The server generates new generation parameters by combining the attribute information, the updated defaults, and the optimized prompt sentence, and encodes these parameters into conditioning values for the generative AI model.
The server again invokes the generative AI model, which processes the optimized conditioning to produce new visual display data that emphasize high-selection-rate components.
The server outputs newly generated images and corresponding metadata, which are stored and then transmitted to the terminal for presentation.

### Step 16:

The terminal receives references to the newly generated visual display data from the server as input.
The terminal retrieves and displays the new images on the display device alongside or in place of previous images, clearly indicating that these images are optimized versions.
The user evaluates these optimized visual display data, and additional interaction events are generated and sent back to the server in the same manner as before.
The terminal outputs continuous feedback in the form of impression and selection events, allowing the server to further refine component preferences and prompt sentences over time.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional systems that generate visual information using a generative artificial intelligence model typically rely on static prompt sentences manually designed by human operators. Such systems suffer from multiple technical limitations. First, the processor of a server generally treats user input (for example, dimensions and basic components of a banner) as fixed parameters and forwards them directly to the generative artificial intelligence model without closed-loop optimization. As a result, the server fails to adapt internal data processing and model interaction to actual user behavior or performance metrics such as click-through rate, thereby causing inefficient utilization of computational resources on the generative artificial intelligence model and suboptimal visual outputs.

Second, conventional architectures often separate the generation pipeline from analytics and emotion recognition pipelines. A processor may log impressions and clicks using external analytics tools, and a separate emotion analysis service may infer user emotional states. However, these streams are not integrated into the core prompt generation and model orchestration logic. Consequently, the server does not exploit time-series feedback (display information, selection information, emotional state information) as direct input features to machine learning models that optimize prompt sentences and component selection. This causes delays in convergence to effective designs, increases network and compute overhead due to repeated trial-and-error generation, and reduces the overall throughput of the content delivery platform.
Third, in many existing systems, optimization logic is executed outside the main server pipeline, for example as an offline batch process. The processor is not configured to update prompt sentences in real time based on predictive performance indices derived from machine learning models. Without such integrated prediction, the server cannot systematically prioritize high-performing combinations of visual components under varying context conditions such as user segment, device type, and emotional state. This leads to redundant invocations of the generative artificial intelligence model, increased latency, and unstable quality of generated visual information.
Fourth, current systems typically implement emotion awareness at the presentation layer only, for example by changing themes or filters on the terminal. The processor in the server does not treat emotional state information as a first-class signal in the data model that governs prompt construction, component ranking, and display order computation. As a result, the system cannot perform low-level computational adjustments such as re-ranking candidate visuals, re-weighting component scores, and generating emotion-conditioned prompt sentences within the core model-inference loop. This diminishes the ability of the server to allocate compute cycles of the generative artificial intelligence model efficiently toward designs that are statistically likely to perform well for the current emotional context. Accordingly, there is a need for a technical mechanism by which a processor can (i) acquire user specifications, (ii) generate and update prompt sentences for a generative artificial intelligence model, (iii) record and analyze time-series feedback including impressions, selections, and emotional states, and (iv) dynamically optimize component selection and display sequencing at the server side. Such a mechanism should improve the way the server stores, processes, and uses data, thereby enhancing the efficiency, responsiveness, and predictive accuracy of the computer system itself, rather than merely automating a human design workflow.

The specific processing by the specific processing unit 290 of the data processing device 12 in Application Example 2 is realized by the following means.

The present invention provides a server comprising a processor configured to receive, from a terminal, dimension information and configuration information for visual information, to generate specification information including the dimension information and the configuration information, to generate, based on the specification information and use history information and evaluation information associated with previously generated visual information, element candidates for optimizing combinations of components of the visual information and a prompt sentence reflecting the element candidates, to input the prompt sentence as generation instruction information to a generative artificial intelligence model and acquire visual information generated by the generative artificial intelligence model, to transmit the generated visual information to the terminal for presentation, to record, as time-series evaluation information, display information and selection information for the visual information transmitted from the terminal, to execute an analysis artificial intelligence model that learns a relationship between the dimension information, the configuration information, and the evaluation information based on the time-series evaluation information and estimates a performance index for each component or combination of components, to update the prompt sentence by selecting, according to the performance index, components to be included in a subsequent prompt sentence to be input to the generative artificial intelligence model, to acquire emotional state information by invoking an emotion analysis model or service based on image information and audio information obtained from the terminal, and to use the emotional state information as an input feature to the analysis artificial intelligence model or as a condition for generation of the prompt sentence, including conditions for adjusting the components or a display order of the visual information in accordance with the emotional state. This enables the server to internally integrate generation, logging, and predictive analysis into a closed feedback loop in which prompt sentences and component selections are automatically optimized based on real-time behavioral and emotional data, thereby improving the efficiency of data processing, reducing redundant invocations of the generative artificial intelligence model, lowering overall latency for delivering effective visual information, and enhancing the technical performance of the computer system that orchestrates generative model interaction and content presentation.

The term “system” refers to a computerized arrangement including at least one server, at least one terminal, and one or more software modules configured to perform acquisition, generation, analysis, and presentation of visual information.

The term “server” refers to an information processing apparatus including at least one processor and at least one memory, configured to execute programs that perform data reception, storage, machine learning, prompt generation, model invocation, and control of visual information delivery.
The term “processor” refers to one or more hardware processing units, such as a central processing unit or a graphics processing unit, configured to execute instructions that implement the functions described in the claims, including data acquisition, model inference, optimization, and control logic.
The term “terminal” refers to an information processing device operated by a user, such as a computing device including a display, input interface, image capture device, and audio capture device, configured to transmit user input and sensor data to the server and to present visual information to the user.
The term “user” refers to an operator or viewer who interacts with the terminal to provide specifications for visual information and to view, select, or otherwise respond to visual information presented by the system.
The term “visual information” refers to content perceivable via sight, including images, graphics, banners, or other visual outputs generated or selected by the system and presented to the user on the terminal.
The term “dimension information” refers to data specifying a size or shape of visual information, including parameters such as width, height, aspect ratio, or resolution that define the spatial extent of the visual information.
The term “configuration information” refers to data specifying structural or stylistic components of visual information, including but not limited to color schemes, layout structures, textual elements, graphical elements, and image elements.
The term “specification information” refers to aggregated data that combines dimension information, configuration information, and optionally additional conditions or constraints, and that serves as a basis for generating a prompt sentence for a generative artificial intelligence model.
The term “component” refers to a constituent element of visual information, including at least one of a color, typeface, layout region, graphical object, image object, textual phrase, or other visual feature that can be individually selected or modified.
The term “combination of components” refers to a set or arrangement of multiple components selected to jointly constitute a specific version of visual information.
The term “element candidate” refers to a component or combination of components identified by the processor as a promising choice for inclusion in visual information, based on specification information, use history information, and evaluation information.
The term “prompt sentence” refers to text-based instruction data that describes desired properties of visual information, including dimension information, configuration information, components, and conditions, and that is input to a generative artificial intelligence model to cause generation of the visual information.
The term “generation instruction information” refers to data provided to a generative artificial intelligence model, including at least a prompt sentence and optionally additional parameters, that defines the content and structure of visual information to be generated.
The term “generative artificial intelligence model” refers to a machine learning model configured to synthesize new data samples, such as images or visual layouts, in response to an input prompt sentence and associated parameters.
The term “analysis artificial intelligence model” refers to a machine learning model configured to analyze stored data, including specification information and evaluation information, and to estimate a performance index or other predictive metrics for components or combinations of components of visual information.
The term “use history information” refers to data describing how previously generated visual information has been delivered and consumed, including identifiers, time of presentation, and contextual conditions observed during past usage.
The term “evaluation information” refers to data indicative of user responses to visual information, including statistics or measurements that quantify performance or effectiveness of the visual information.
The term “display information” refers to data representing events in which visual information is presented to the user on the terminal, including at least a number of times the visual information is displayed and contextual metadata associated with such displays.
The term “selection information” refers to data representing user selection actions with respect to visual information, including events such as clicks, taps, or activations, and associated metadata including identifiers of the selected visual information.
The term “display count information” refers to data representing a number of times visual information has been displayed to users, optionally broken down by time interval, user segment, or other context.
The term “selection count information” refers to data representing a number of times visual information has been selected by users, optionally broken down by time interval, user segment, or other context.
The term “time-series evaluation information” refers to evaluation information, including display information and selection information, that is stored together with temporal identifiers such as timestamps or sequence indices so that changes over time can be analyzed.
The term “performance index” refers to a quantitative measure representing predicted or observed effectiveness of a component or combination of components of visual information, including metrics such as click-through probability, selection likelihood, or other performance-related values.
The term “emotional state” refers to a psychological condition of a user, such as joy, sadness, excitement, or relaxation, inferred from sensor data and used as a variable for adapting generation and presentation of visual information.
The term “emotional state information” refers to data indicating an estimated emotional state of a user, including emotion labels and associated confidence values, obtained through analysis of image information, audio information, or other sensor signals.
The term “emotion analysis model” refers to a machine learning model configured to infer an emotional state of a user based on input data such as facial images, body posture images, or voice audio.
The term “emotion analysis service” refers to an external or internal software service that receives sensor data and outputs emotional state information using an emotion analysis model.
The term “image information” refers to visual sensor data, such as digital images or video frames, captured by a camera of the terminal and used for at least emotion analysis or other processing.
The term “audio information” refers to acoustic sensor data, such as voice or ambient sound signals, captured by a microphone of the terminal and used for at least emotion analysis or other processing.
The term “display order” refers to a sequence in which multiple pieces of visual information are arranged for presentation to the user on the terminal.
The term “input feature” refers to a variable or attribute, such as emotional state information, specification information, or evaluation information, that is provided as input to a machine learning model for training or inference.
The term “predetermined condition” refers to a rule or threshold, defined in advance or learned by a model, that specifies criteria for selecting a combination of components based on its performance index.
The term “regeneration” refers to a process in which the generative artificial intelligence model is instructed, based on an updated prompt sentence, to generate new visual information or new variants of existing visual information.
The term “presentation” refers to the act of displaying or otherwise rendering visual information on the terminal for viewing by the user, under control of the server.
The term “closed feedback loop” refers to an operational pattern in which outputs from the generative artificial intelligence model and subsequent user behavior and emotional state information are fed back into the server's models and prompt generation logic to iteratively refine future outputs.

In one embodiment, a server cooperates with one or more terminals operated by a user to provide optimized visual information generated by a generative AI model on the basis of prompt sentences that are iteratively refined using behavioral and emotional feedback. The server comprises at least one processor, a main memory, a non-volatile storage device, a communication interface, and optionally one or more hardware accelerators such as a graphics processing unit. The server executes an operating system and application software modules implemented, for example, in a programming language such as Python or JavaScript. The server executes machine learning libraries such as a tensor computation library or a neural network framework (for example, a deep learning framework of the type commonly known as TensorFlow or PyTorch) to implement a generative AI model and an analysis AI model.

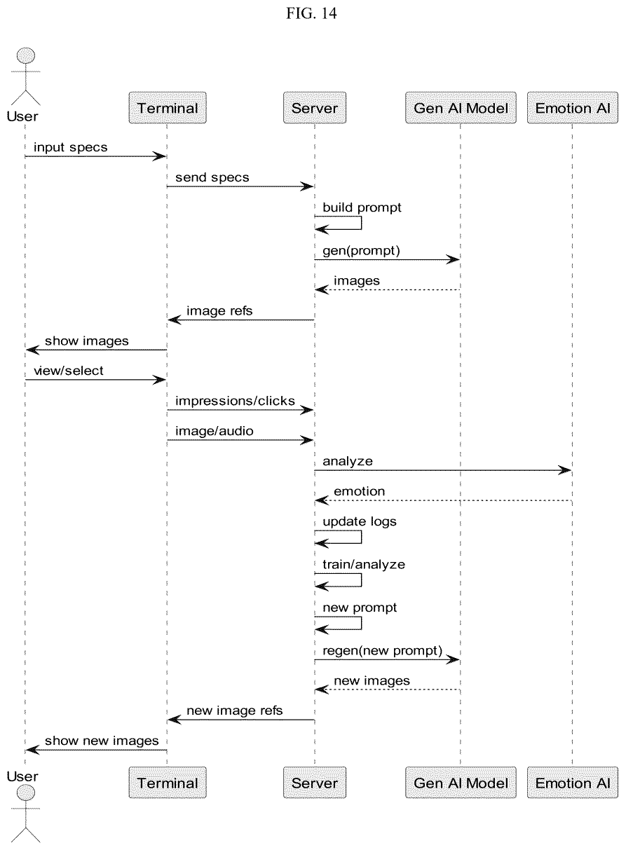

The terminal comprises at least one processor, a display unit, an input unit, a camera, and a microphone. The terminal executes a web browser or a native application. The terminal executes a user interface module implemented, for example, in a cross-platform UI library such as a mobile UI framework or a web UI framework. The terminal communicates with the server via a communication network such as the Internet.
The user operates the terminal to specify dimension information and configuration information for visual information. The user, for example, inputs a desired width and height for a banner, a preferred color tone, text content, and an indication of a target audience. The terminal transmits this information to the server in the form of structured data. The server stores the received information in a data storage system such as a relational database or a document-oriented database.
The server generates specification information by aggregating the dimension information and the configuration information received from the terminal. The server represents the specification information as a data structure containing fields such as width, height, background color category, font style category, layout pattern identifier, and target audience category. The server normalizes raw values into discrete categories or numerical encodings suitable for input to machine learning models. For example, the server encodes background color into a one-hot vector over a fixed set of color categories and encodes target audience into a one-hot or multi-hot vector over predefined demographic segments.
The server generates a prompt sentence for a generative AI model based on the specification information. The server constructs the prompt sentence by concatenating textual templates with values derived from the specification information and with additional conditions determined by the analysis AI model. In one example, the server constructs a prompt sentence such as:
“Generate a 300×250 pixel advertising banner with a blue background, a large white bold headline text, and a centered product image, targeting women in their twenties, optimized for a high click-through rate.”
   In another example, the server constructs a prompt sentence that incorporates a promotional theme:
“Generate a 300×250 pixel banner for a summer sale with bright colors, a clear ‘50% OFF’ message, and a central product image that appeals to young adults.”
   The server uses a generative AI model configured to synthesize images from such textual prompt sentences. In one embodiment, the generative AI model is an image generation neural network of the diffusion model type or an encoder-decoder transformer architecture. The server represents the prompt sentence as a sequence of token identifiers using a tokenizer, and the generative AI model embeds the tokens into vectors in a high-dimensional space. The generative AI model processes these vectors through multiple layers of attention and non-linear transformations and iteratively refines latent image representations. The generative AI model outputs one or more images representing visual information that satisfies the conditions described by the prompt sentence.
   The server stores the generated images in an image storage subsystem. The server associates each stored image with metadata including the original specification information, the prompt sentence, and identifiers for the user and campaign. The server records the storage location or URL for each generated image in the database.
   The terminal receives references to the generated images from the server and downloads the image data via a secure network protocol. The terminal displays the visual information to the user on the display unit. The user views the images, may scroll between multiple variants, and may select one or more preferred variants. The terminal generates display information and selection information. The display information includes, for example, the time at which each image is shown and an indication that the image has been visible on the screen for at least a given duration. The selection information includes events such as clicks or taps performed by the user on the images.
   The terminal transmits the display information and selection information to the server. The server receives these signals and records them as time-series evaluation information. The server aggregates display count information and selection count information per image, per user segment, per device type, and per time interval.
   The server executes an analysis AI model to learn and predict a performance index for components and combinations of components of visual information. In one embodiment, the analysis AI model is a feedforward neural network that receives as input a feature vector constructed from the specification information and context information, and outputs a predicted probability of selection or click-through. The feature vector includes encoded dimension information (for example, normalized width and height), encoded configuration information (for example, one-hot codes for background color, layout type, font type, and image type), user segment information, device type information, and emotional state information described below.
   The server trains the analysis AI model using historical evaluation information as supervised labels. The server uses, for example, a binary classification objective in which the label indicates whether a given impression resulted in a selection. The server defines a loss function such as binary cross-entropy between predicted probabilities and actual outcomes. The server applies stochastic gradient descent or a variant such as Adam optimization to update the model parameters, including weights and biases of each neural network layer.
   The server performs training by repeatedly selecting batches of training samples from the database, computing forward passes through the analysis AI model to obtain predictions, computing gradients of the loss function with respect to the model parameters by backpropagation, and updating the parameters. The server optionally applies regularization methods such as dropout or weight decay. The server evaluates model performance on validation data sets and may adjust hyperparameters such as learning rate, number of layers, and number of units per layer.
   In order to improve generalization and robustness, the server may apply data augmentation at the feature level. The server may, for example, slightly jitter continuous features such as brightness or contrast metrics derived from images, or group similar color categories together during training to avoid overfitting to rare colors.
   The server uses the trained analysis AI model in inference mode to compute the performance index for candidate combinations of components. The server constructs a set of candidate component combinations by varying, for example, background color, headline position, text length, and image placement. For each candidate, the server constructs a feature vector representing that hypothetical visual information under a given context and provides it to the analysis AI model to obtain a predicted performance index.
   The server ranks the candidate combinations based on the predicted performance indices. The server selects one or more top-ranked combinations and reflects them in an updated prompt sentence. The server thereby causes the generative AI model to generate new visual information corresponding to component combinations that the analysis AI model predicts to be more effective. This feedback-based selection and prompt refinement is not achievable by manual human design alone, because the server utilizes high-dimensional feature spaces and non-linear relationships learned automatically from historical data.
   The server further incorporates emotional state information into the analysis. The terminal uses the camera and microphone to capture image information and audio information while the user is viewing visual information. The terminal may preprocess this data by down-sampling frames or compressing audio. The terminal transmits the data or extracted features to the server. The server invokes an emotion analysis model or an external emotion analysis service, which may itself be a neural network configured, for example, as a convolutional neural network for image-based emotion recognition and a recurrent or transformer-based model for audio-based emotion recognition.
   The server receives emotional state information from the emotion analysis model, including labels such as “joy,” “neutral,” “sad,” “excited,” or “relaxed,” and associated confidence scores. The server stores the emotional state information alongside impression records and uses it as an input feature to the analysis AI model. The server also uses emotional state information as a condition for prompt sentence generation. For example, when the emotional state information indicates joy, the server may add text such as:
“When the user is happy, generate a banner with bright colors and a positive message encouraging immediate purchase.”
   When the emotional state indicates relaxation, the server may add text such as:
“Generate a calming banner with soft colors and a message promoting comfortable lifestyle products.”
   By combining emotional state information with performance predictions, the server can adapt prompt sentences and generated visual information to changing user conditions in real time.
   The server implements specific data structures and processing flows to achieve technical improvements. The server uses normalized specification vectors, time-stamped evaluation logs, and emotion feature vectors stored in separate but linked database tables. The server performs batch training and online inference of the analysis AI model using optimized matrix operations on hardware accelerators. The server caches frequently used model parameters and feature normalizers in main memory to reduce repeated disk access, thereby decreasing latency. The server minimizes network usage by transmitting compact feature vectors and using identifiers instead of raw media where possible.
   The server thus improves computer technology itself by reducing the number of calls to the generative AI model needed to reach an effective design. Because the server predicts a performance index for many combinations without generating each corresponding image, the server avoids unnecessary high-cost image synthesis operations and reduces overall computation time. The server also reduces storage requirements by not persisting images for combinations predicted to perform poorly. The iterative feedback loop, in which the analysis AI model continuously refines its predictions as new evaluation and emotional data are collected, leads to improved accuracy in performance estimation, which in turn results in more targeted usage of computational resources.
   The server implements decision-making logic that differs from human manual design. The server automatically learns non-intuitive correlations between dimensions, color schemes, layouts, emotion states, and performance. For example, the server may learn that, for a certain user segment and emotional state, a medium-sized headline and a darker background yield a higher performance index than a large headline and a bright background, even if human intuition might suggest otherwise. The server reflects such learned rules in prompt sentences through algorithmic ranking and selection, not through fixed, manual heuristics.
   The server may employ alternative architectures for the generative AI model and the analysis AI model. For the generative AI model, the server may use a transformer-based text-to-image architecture, a diffusion-based model with a U-Net backbone, or a generative adversarial network. For the analysis AI model, the server may use a gradient-boosted decision tree algorithm instead of a neural network when the feature space is predominantly tabular. The server may use different loss functions, such as focal loss in cases with highly imbalanced selection labels, or mean squared error when predicting expected numeric click counts.
   The system is applicable to multiple use cases where the server dynamically controls visual outputs on the basis of performance feedback and emotional context. For example, the user may instruct the server via the terminal with a prompt sentence such as:
“Generate a 300×250 banner for a new product promotion, with a clean layout and a clear call-to-action, targeting first-time visitors.”
   The server can generate a first set of images, observe which variants are selected, record emotional responses, and then generate refined prompt sentences such as:
“Generate a 300×250 banner for a new product promotion, with a blue background, the call-to-action button at the bottom-right, and a concise headline, optimized for users who previously showed excitement.”
   The terminal then presents these refined visuals. This cycle repeats until the system converges on configurations that yield high performance indices. The described operations occur within and between concrete computing devices (the server and terminals) and modify internal data structures (feature vectors, model parameters, logs, and prompt templates) in a specific manner that yields measurable improvements in processing efficiency, prediction quality, and resource usage.
   The system is not limited to any particular hardware or software platform. The server may run in a cloud computing environment, on a local data center, or as a distributed cluster. The terminal may be a smartphone, a tablet, a notebook computer, or a set-top box. The database may be implemented using any suitable technology that supports indexed queries and time-series data. The generative AI model and analysis AI model may be deployed as local libraries on the server or as remote services accessible via application programming interfaces.
   In alternative embodiments, the server may adjust not only visual components but also the scheduling and frequency of content delivery based on performance indices and emotional states. The server may decide, for example, to delay or skip the generation of new variants when the current performance index remains above a threshold, thereby further reducing computational load. The server may also partition the analysis AI model by user segment or device type for improved accuracy and lower inference latency.
   Through these concrete arrangements of server, terminal, and machine learning modules, the system achieves technical effects including faster convergence toward high-performing visual information, reduced computational burden on the generative AI model, improved prediction accuracy of the analysis AI model, and more efficient data storage and transmission. These improvements arise from the specific combination of prompt sentence generation, feature encoding, model training and inference, and real-time feedback integration, and not merely from automating a human design process.
   The following describes the processing flow using FIG. 14.

### Step 1:

The user operates the terminal to open an application or web page and to input requirements for visual information.
The input includes dimension information (for example, width and height), configuration information (for example, background color, text content, layout preference, target audience), and optional constraints (for example, “optimize for high click-through rate”).
The terminal validates the input format (for example, checks that width and height are positive integers and that required fields are present) and converts the raw UI values into a structured data object.
The terminal outputs a structured request containing the normalized specification information and transmits this request to the server via a network interface using a defined communication protocol.

### Step 2:

The server receives the structured request from the terminal and parses the payload to extract dimension information, configuration information, and context information (for example, user identifier, device type, session identifier).
The input to this step is the structured request, and the output is an internal specification record stored in a persistent storage system.
The server performs data processing by mapping categorical inputs (for example, color names, layout types) to numeric codes or one-hot vectors and by normalizing numeric values (for example, scaling width and height).
The server writes the processed specification record into a database, associating it with identifiers that will later link to generated visual information and evaluation information.

### Step 3:

The server generates a prompt sentence for a generative AI model based on the stored specification record.
The input to this step is the normalized specification record, and the output is a textual prompt sentence that encodes the requested properties of the visual information.
The server concatenates template text segments with encoded values from the specification record (for example, dimension, color, layout) and optionally with rules learned from previous performance data (for example, preference for bold headlines).
The server outputs a complete prompt sentence such as “Generate a 300×250 pixel advertising banner with a blue background, a large white bold headline text, and a centered product image, targeting young adults, optimized for a high click-through rate,” and stores this prompt sentence in the database.

### Step 4:

The server prepares a generation instruction payload for the generative AI model, embedding the prompt sentence and additional generation parameters (for example, output size, number of variants, style constraints).
The input to this step is the prompt sentence and model configuration data, and the output is a request object suitable for the generative AI model's interface.
The server formats the request according to the model API specification, including tokenizing the prompt sentence and setting numeric parameters such as image width and height.
The server sends the request object to the generative AI model hosted either locally or as a remote service and waits for the model's response.

### Step 5:

The server receives the output of the generative AI model, which consists of one or more images representing visual information, along with related metadata.
The input to this step is the model response (for example, base64-encoded images, latent representations), and the output is a set of decoded and stored image files with associated identifiers.
The server decodes the image data, verifies the image dimensions and integrity, and generates unique IDs for each generated image.
The server stores the image data in an image repository and records links between image IDs, the originating prompt sentence, and the specification record in the database.

### Step 6:

The server sends to the terminal a response that contains references to the generated images (for example, URLs) and metadata needed for display (for example, variant indices, thumbnail URLs).
The input to this step is the set of stored image IDs and locations, and the output is a structured response payload delivered over the network to the terminal.
The server may compress metadata and sign URLs to ensure secure and efficient transmission.
The server transmits the response via an application-level protocol, enabling the terminal to retrieve and display the visual information.

### Step 7:

The terminal receives the response from the server, parses the metadata, and initiates download of the image files referenced by the URLs.
The input to this step is the response payload from the server, and the output is in-memory image objects ready for rendering on the display.
The terminal performs data processing by issuing HTTP requests for each image URL, decoding the image data, and storing them in a graphics buffer or image cache.
The terminal then renders the images in a user interface component, such as a gallery or carousel, so that the user can visually inspect multiple variants.

### Step 8:

The user views the displayed images on the terminal and optionally selects one or more images by tapping or clicking them.
The input to this step is the rendered visual information, and the output is a set of user interaction events (for example, view events and selection events).
The user may scroll to reveal additional images, open a detail view, or activate a call-to-action associated with an image.
The terminal captures these interactions as structured events containing at least a timestamp, image ID, and event type, and temporarily buffers them for transmission.

### Step 9:

The terminal records impression information when an image becomes visible on the screen for at least a predetermined duration, and records selection information when the user clicks or taps on a particular image.
The input to this step is the stream of low-level UI events and visibility signals, and the output is aggregated display information and selection information.
The terminal performs computations to determine when an image is in the visible viewport and increments the display count accordingly, and creates selection events when selection input is detected.
The terminal periodically batches these events and sends them to the server as evaluation data, including identifiers and context (for example, screen type, session ID).

### Step 10:

The server receives the evaluation data from the terminal and updates the time-series evaluation records in the database.
The input to this step is the batched evaluation data (display information and selection information), and the output is updated statistics for each image and component combination.
The server aggregates counts by summing display and selection events per image ID and computing derived metrics such as click-through rate.
The server stores both raw event logs and aggregated statistics, linking them with the corresponding prompt sentences and specification records.

### Step 11:

The terminal captures image information and audio information of the user while the user is viewing the visual information, subject to user consent and configuration.
The input to this step is the raw sensor data streams from the camera and microphone, and the output is preprocessed media data suitable for emotion analysis.
The terminal may reduce resolution or frame rate, detect faces, or normalize audio volume to create compact representations.
The terminal transmits the preprocessed image and audio data, or extracted features, to the server or directly to an emotion analysis service.

### Step 12:

The server obtains emotional state information by invoking an emotion analysis model or service using the received media data as input.
The input to this step is the sensor-derived image information and audio information, and the output is emotional state information that includes emotion labels and confidence scores.
The server formats the media data into the required input format for the emotion analysis model, calls the model or service, and receives predicted emotional categories such as joy, neutral, or sadness.
The server stores the emotional state information alongside evaluation data, associating each emotional state with the corresponding visual information and timestamp.

### Step 13:

The server constructs training data for an analysis AI model by combining specification information, evaluation information, and emotional state information into feature-label pairs.
The input to this step is the joined historical dataset containing component encodings, context attributes, and observed selection outcomes, and the output is a prepared training dataset.
The server encodes categorical features into numeric vectors (for example, one-hot encoding) and normalizes continuous features (for example, min-max scaling), and sets labels such as whether a selection occurred for a given impression.
The server shuffles and partitions the training data into training and validation sets, ensuring that temporal and contextual diversity is preserved.

### Step 14:

The server trains the analysis AI model using the prepared training dataset to estimate a performance index for components and combinations of components.
The input to this step is the training dataset and model hyperparameters, and the output is an updated model with learned parameters that approximate the relationship between features and performance.
The server performs numerical computations such as forward passes, loss computation (for example, cross-entropy), gradient computation via backpropagation, and parameter updates using an optimization algorithm.
The server evaluates the model on validation data, calculates metrics such as accuracy or area under the curve, and may adjust hyperparameters or network architecture to improve predictive performance.

### Step 15:

The server uses the trained analysis AI model in inference mode to score candidate combinations of components under specified context conditions.
The input to this step is a list of candidate component combinations and associated context features (for example, target segment, typical emotional state), and the output is a set of predicted performance indices.
The server encodes each candidate combination into a feature vector in the same format used for training and passes the feature vectors through the analysis AI model to obtain predicted probabilities or scores.
The server ranks candidates by their predicted performance indices, thereby determining which combinations of components should be favored in subsequent generation cycles.

### Step 16:

The server generates an updated prompt sentence that reflects the highest-ranked components and combinational patterns identified by the analysis AI model.
The input to this step is the ranked list of components and the original specification information, and the output is a refined prompt sentence tailored to maximize the expected performance index.
The server selects components such as background color, text style, and layout position based on their scores and integrates them into the textual template for the prompt sentence.
The server may also embed conditions related to emotional state, such as specifying bright colors and energetic wording for excited users or calm colors and reassuring messages for relaxed users, and stores the new prompt sentence in the database.

### Step 17:

The server transmits the updated prompt sentence to the generative AI model to cause regeneration of new or modified visual information.
The input to this step is the refined prompt sentence and updated generation parameters, and the output is a new set of generated images that are expected to perform better according to the analysis AI model.
The server repeats the formatting and API invocation procedures used earlier, sending the updated prompt to the generative AI model and receiving the resulting images.
The server again stores the regenerated images, links them to the new prompt and previous performance data, and prepares them for delivery to the terminal.

### Step 18:

The terminal receives the regenerated image references from the server and displays the updated visual information to the user as part of a continuous optimization cycle.
The input to this step is the new response payload from the server containing regenerated image URLs and metadata, and the output is a refreshed user interface showing optimized visuals.
The terminal replaces or supplements previous images with the regenerated ones, ensuring that display order and emphasis reflect any conditions provided by the server, such as prioritizing ads that match the current emotional state.
The terminal continues to collect new display, selection, and sensor data, feeding them back to the server so that the optimization loop can proceed with more accurate data and improved computational efficiency.
The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

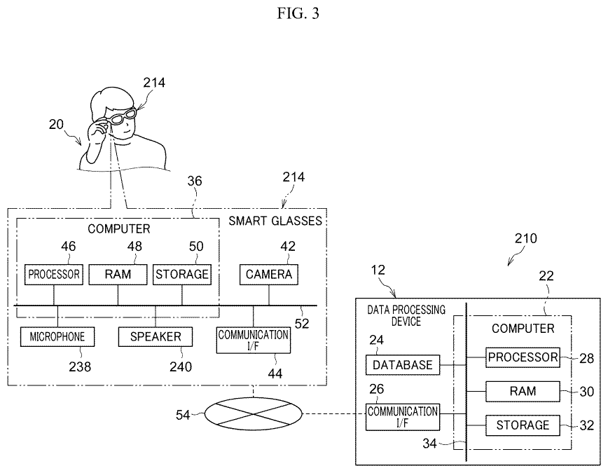

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

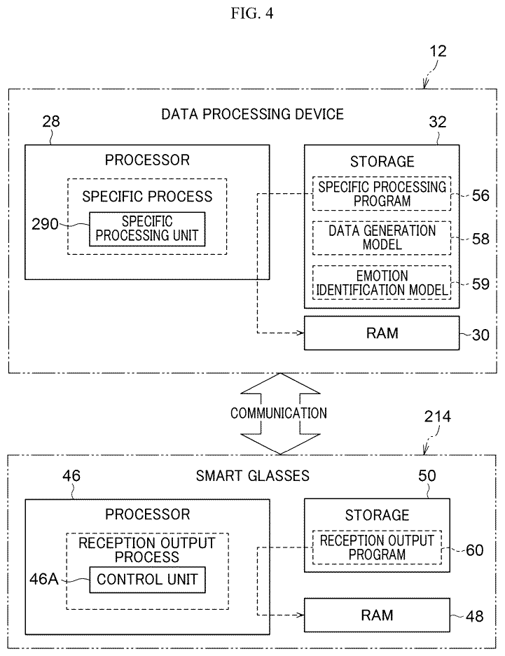

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

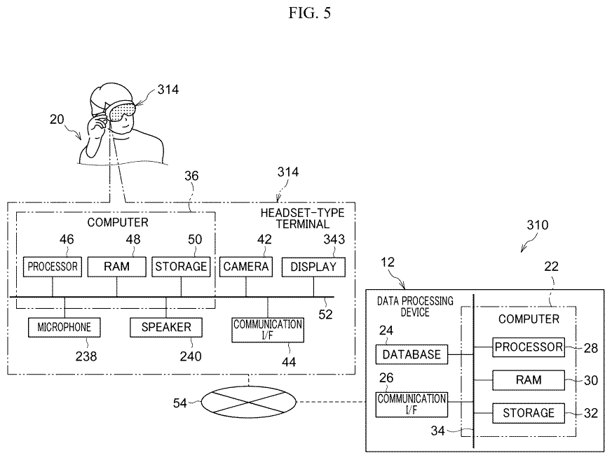

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

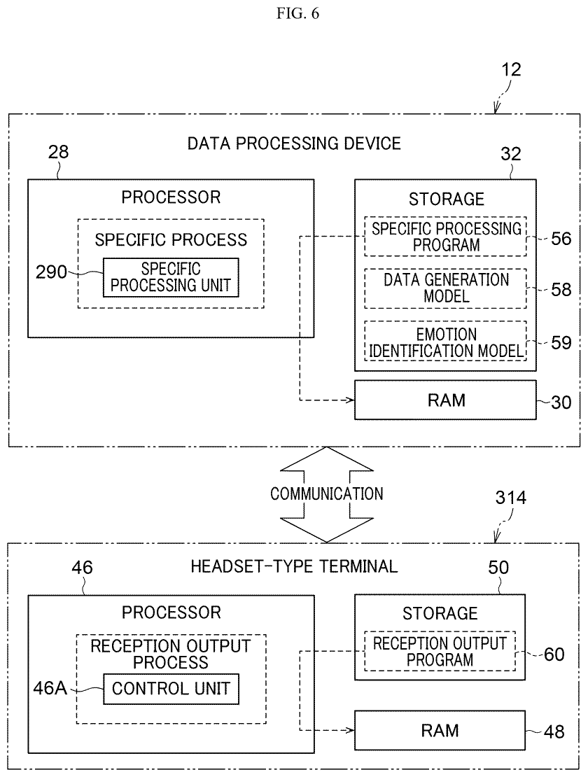

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

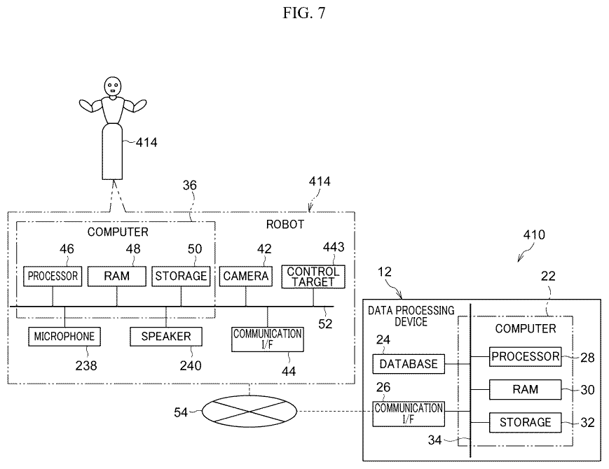

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

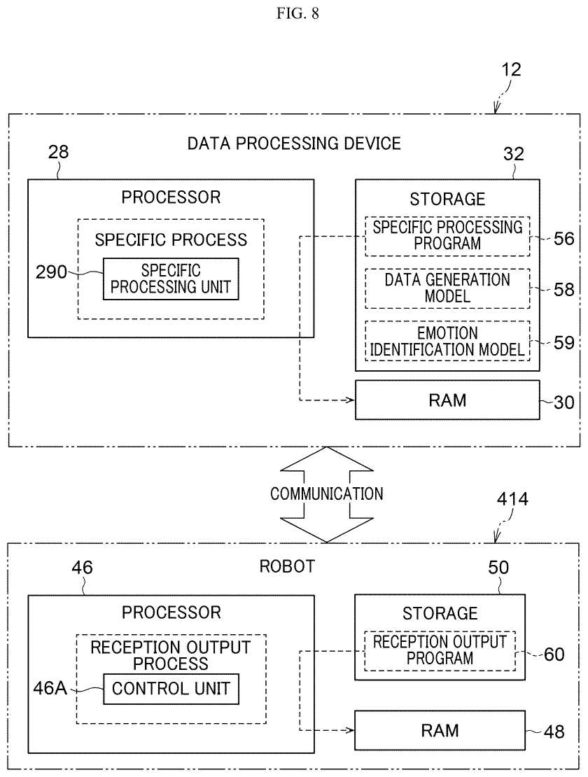

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

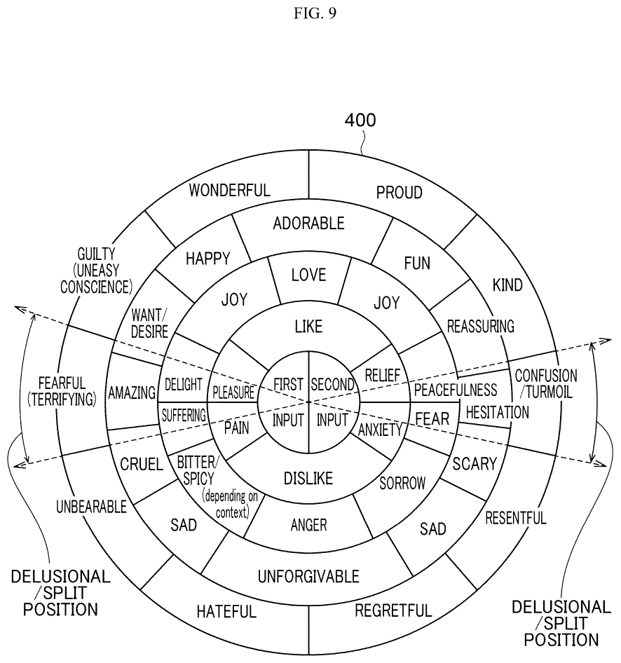

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

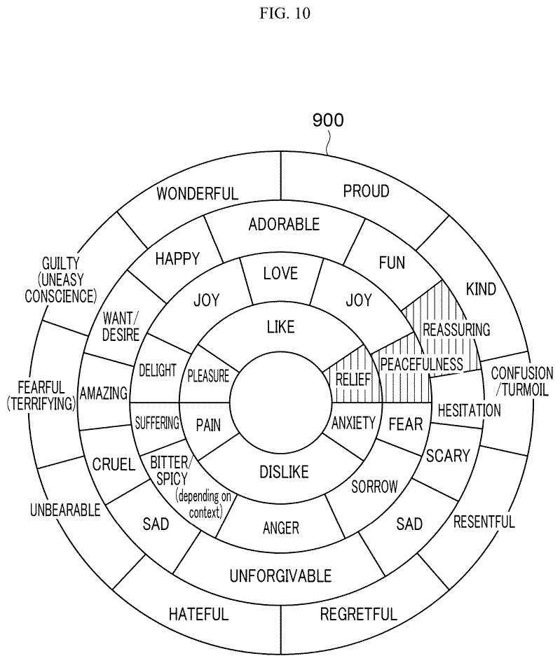

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a storage device,
wherein the processor is configured to
receive, via a communication interface from a user terminal, attribute information including size information of a visual representation and configuration information of the visual representation, the attribute information being input by a user through an operation screen displayed on the user terminal,
convert the received attribute information into a prompt sentence structured as a natural-language instruction that describes generation conditions including at least the size information and the configuration information of the visual representation, and generate the prompt sentence as model input information for a generative AI model,
transmit, via a communication network, the prompt sentence and image generation parameters associated with the prompt sentence as model input information to the generative AI model, and cause the generative AI model to execute an image generation process based on the prompt sentence,
receive, from the generative AI model via the communication network, image data of a visual representation generated based on the prompt sentence, store the image data in the storage device, and transmit the image data or reference information to the image data to the user terminal so as to cause the user terminal to display the visual representation on a display apparatus, and
record, in the storage device, the prompt sentence and supplementary information associated with the visual representation.

### (Supplementary 2)

The system according to supplementary 1,
wherein the processor is configured to
monitor selection operation information regarding the visual representation transmitted from the user terminal, calculate a selection rate for each visual representation based on a number of selections and a number of presentations of the visual representation, and, based on the calculated selection rate, automatically generate a new prompt sentence including content for changing the configuration information of the visual representation, and transmit the new prompt sentence to the generative AI model so as to instruct generation of a different visual representation.

### (Supplementary 3)

The system according to supplementary 1,
wherein the processor is configured to
adjust the prompt sentence such that configuration information extracted from a visual representation whose selection rate calculated according to supplementary 2 satisfies a predetermined condition is described in the prompt sentence as high-priority generation conditions, and retransmit the adjusted prompt sentence to the generative AI model so as to instruct the generative AI model to regenerate a visual representation reflecting the configuration information having the high selection rate.

### Application Example 1

### (Supplementary 1)

A system comprising a processor and a storage device,
wherein the processor is configured to
acquire user input including dimension information and configuration information from a user terminal, and convert the user input into structured information that is normalized according to a predetermined format,
generate a prompt sentence in a natural language including at least a dimension condition, a background condition, text information, and image information based on the structured information, and convert the prompt sentence into model input information adapted to a generative AI model,
execute the generative AI model using the model input information to obtain a generation result including visual output information corresponding to the prompt sentence,
perform, based on the generation result, a compositing process and a text rendering process on the visual output information by using an image processing function, to generate visual display information having a predetermined dimension,
store the visual display information and attribute information corresponding to the prompt sentence in the storage device, and transmit the visual display information to the user terminal for display on the user terminal, and
acquire editing operation information from the user terminal, update the structured information and the prompt sentence based on the editing operation information, and cause the generative AI model to perform regeneration by using the updated prompt sentence.

### (Supplementary 2)

The system according to supplementary 1,
wherein the processor is configured to
monitor selection operations of a plurality of pieces of visual display information on the user terminal based on operations of the user, calculate a selection evaluation value based on the selection operations, automatically modify a description content of the prompt sentence so as to change a priority of the configuration information according to the selection evaluation value, generate a new prompt sentence, and cause the generative AI model to receive the new prompt sentence as input.

### (Supplementary 3)

The system according to supplementary 1,
wherein the processor is configured to
extract configuration information included in visual display information having a high selection evaluation value, adjust at least one of a description order and a description content of the dimension condition, the background condition, the text information, and the image information in the prompt sentence such that the extracted configuration information is preferentially included, and cause the generative AI model to perform regeneration of the visual display information by using the adjusted prompt sentence.

### Example 2

### (Supplementary 1)

A system comprising a processor,
wherein the processor is configured to
receive, from a terminal operated by a user, attribute information including dimension information and component information, and a prompt sentence for use with a generative AI model,
generate, based on the attribute information, generation parameters including the prompt sentence, image size information, color attribute information, and layout attribute information, and input the generation parameters to the generative AI model to cause the generative AI model to generate a plurality of visual display data,
store, in a storage device, the plurality of visual display data acquired from the generative AI model and identification information corresponding to each of the plurality of visual display data, and manage the identification information in association with the attribute information, transmit the visual display data stored in the storage device to the terminal and cause the terminal to present the visual display data,
acquire, from the terminal, operation information relating to numbers of times of display and numbers of times of selection for each of the plurality of visual display data in accordance with the presentation on the terminal, and record the numbers of times of display and the numbers of times of selection in association with the identification information,
calculate, based on the numbers of times of display and the numbers of times of selection, selection rates for each of the plurality of visual display data and for each component constituting the plurality of visual display data, and aggregate the selection rates for each component to identify high-selection-rate components,
automatically adjust the prompt sentence and the generation parameters such that the identified high-selection-rate components are preferentially included, and input the adjusted prompt sentence and adjusted generation parameters to the generative AI model to cause the generative AI model to regenerate new visual display data, and
transmit the new visual display data reflecting the high-selection-rate components to the terminal and cause the terminal to present the new visual display data.

### (Supplementary 2)

The system according to supplementary 1,
wherein the processor is configured to classify, as component units, components including button color, text information, arrangement pattern, and background color based on the calculated selection rates, to extract the high-selection-rate components from among the classified components, and to update initial values of the generation parameters such that the extracted high-selection-rate components are selected as default components.

### (Supplementary 3)

The system according to supplementary 1,
wherein the processor is configured to manage the prompt sentence as a template, to automatically insert or replace descriptions corresponding to the high-selection-rate components in the template, and, when new attribute information is input from the user, to
generate an optimized prompt sentence combining the new attribute information and the high-selection-rate components, and to instruct the generative AI model to regenerate the visual display data based on the optimized prompt sentence.

### Application Example 2

### (Supplementary 1)

A system comprising a processor,
wherein the processor is configured to
receive dimension information and configuration information regarding visual information from a user through a terminal, and generate specification information including the received dimension information and configuration information,
generate, based on the specification information and on use history information and evaluation information previously obtained for visual information, element candidates for optimizing a combination of components of the visual information, and generate a prompt sentence reflecting the element candidates,
input the prompt sentence, as generation instruction information, to a generative artificial intelligence model to cause the generative artificial intelligence model to generate the visual information, and acquire the visual information from the generative artificial intelligence model,
transmit the acquired visual information to the terminal and cause the visual information to be presented to the user by display control at the terminal,
record, based on display information and selection information for the visual information transmitted from the terminal, evaluation information for each piece of the visual information, the evaluation information including display count information and selection count information,
execute an analysis artificial intelligence model that learns a relationship between the dimension information and the configuration information and the evaluation information, based on the display count information and the selection count information, and estimate a performance index for components of the visual information,
select, based on the performance index, components to be included in a prompt sentence to be input to the generative artificial intelligence model in a subsequent generation, and update contents of the prompt sentence,
acquire emotional state information by calling an emotion analysis model or an emotion analysis service configured to estimate an emotional state of the user, based on image information and audio information obtained from the terminal, and use the emotional state information as input to the analysis artificial intelligence model or as a condition for generation of the prompt sentence, and
add, in accordance with the emotional state information, conditions for adjusting the components or a display order of the visual information to the prompt sentence, and control the visual information presented to the user in accordance with the emotional state.

### (Supplementary 2)

The system according to supplementary 1,
wherein the processor is configured to
store, in time series, the display information, the selection information, and the emotional state information transmitted from the terminal, and periodically retrain the analysis artificial intelligence model based on stored information, thereby continuously updating the components and descriptive contents included in the prompt sentence.

### (Supplementary 3)

The system according to supplementary 1,
wherein the processor is configured to
calculate, based on an estimation result of the analysis artificial intelligence model, the performance index for each combination of a plurality of components of the visual information, and, by preferentially reflecting in the prompt sentence a combination of components whose performance index satisfies a predetermined condition, instruct the generative artificial intelligence model to regenerate the visual information.

What is claimed is:

1. A system comprising:
circuitry configured to:
receive, via a packet-switched network from a terminal, attribute data including dimension parameters and configuration parameters for visual content;
convert the attribute data into a structured generation instruction by mapping the dimension parameters to size constraint values and the configuration parameters to descriptive text segments, and generate, based on the structured generation instruction, a prompt sequence expressed as a natural-language instruction for a generative model;
transmit the prompt sequence and associated generation parameters as data packets via the packet-switched network to a generative model node;
receive, from the generative model node, generated visual data corresponding to the prompt sequence, and store the generated visual data and associated metadata in a storage;
transmit the generated visual data as data packets via the packet-switched network to the terminal for rendering, and monitor interaction event data including impression events and selection events received from the terminal; and
compute a selection metric for each item of the generated visual data based on a ratio of the selection events to the impression events, modify the prompt sequence to preferentially incorporate configuration parameters associated with items of the generated visual data whose selection metric exceeds a predetermined threshold, and retransmit the modified prompt sequence to the generative model node to cause the generative model node to regenerate visual data.

2. The system according to claim 1, wherein the circuitry is configured to normalize the attribute data to a predetermined format by mapping categorical values of the configuration parameters to numeric codes and scaling numeric values of the dimension parameters to a normalized range.

3. The system according to claim 2, wherein the prompt sequence includes a dimension condition derived from the dimension parameters, a background condition, text information, and image information, each concatenated from template segments stored in the storage.

4. The system according to claim 3, wherein the generation parameters include token embeddings generated by encoding the prompt sequence through a text encoder network and projection vectors derived from the dimension parameters and color attribute values, and wherein the generative model node executes a diffusion-based image generation network that iteratively denoises a latent representation conditioned on the token embeddings and the projection vectors.

5. The system according to claim 1, wherein the circuitry is configured to cause the generative model node to generate a plurality of items of visual data from the prompt sequence, assign identification data to each item, and store the plurality of items and the identification data in the storage in association with the prompt sequence.

6. The system according to claim 5, wherein the circuitry is configured to decompose each item of the generated visual data into constituent component types including color attributes, text style attributes, and layout pattern attributes, compute a component-level selection metric for each constituent component type by aggregating the selection events across items sharing a common component value, and identify high-selection-rate components whose component-level selection metric exceeds a predetermined condition.

7. The system according to claim 6, wherein the circuitry is configured to update default values of the generation parameters to preferentially select the identified high-selection-rate components, such that when subsequent attribute data is received from the terminal, the generation parameters incorporate the updated default values as baseline configuration parameters.

8. The system according to claim 1, wherein the circuitry is configured to receive, from the terminal via the packet-switched network, editing operation data indicating a modification to the configuration parameters, update the structured generation instruction based on the editing operation data, generate an updated prompt sequence from the updated structured generation instruction, and retransmit the updated prompt sequence to the generative model node to cause the generative model node to regenerate visual data.

9. The system according to claim 8, wherein the circuitry is configured to perform a compositing process on the generated visual data by overlaying image elements at computed placement coordinates using alpha blending operations and rendering text elements at calculated positions with specified font parameters and size parameters to produce composite visual data conforming to the dimension parameters.

10. The system according to claim 9, wherein the circuitry is configured to store the generated visual data, the prompt sequence, and the attribute data as associated records in the storage, and retrieve the associated records for use in subsequent generation iterations.

11. The system according to claim 10, wherein the circuitry is configured to manage the prompt sequence as a template data structure having placeholder positions, insert descriptions corresponding to the identified high-selection-rate components into the placeholder positions, and combine the inserted descriptions with newly received attribute data to generate an optimized prompt sequence for transmission to the generative model node.

12. The system according to claim 1, wherein the circuitry is configured to acquire image data and audio data captured at the terminal, transmit the image data and the audio data to an emotion analysis model, and receive emotional state data from the emotion analysis model, the emotional state data indicating an estimated emotional state of a user of the terminal.

13. The system according to claim 12, wherein the circuitry is configured to store the emotional state data in association with the interaction event data as time-series evaluation records, and use the emotional state data as an input feature to an analysis model configured to estimate a performance index for combinations of the configuration parameters.

14. The system according to claim 13, wherein the circuitry is configured to modify content of the prompt sequence and a display ordering of components of the generated visual data based on the emotional state data, including adding conditions for adjusting visual parameters in accordance with the detected emotional state.

15. The system according to claim 1, wherein the circuitry is configured to store the impression events, the selection events, and emotional state data as time-series evaluation records in the storage, and construct training data by encoding the configuration parameters and context attributes as feature vectors with the selection events as label data.

16. The system according to claim 15, wherein the circuitry is configured to execute an analysis model on the training data by performing forward computation, loss computation, and gradient-based parameter updates to learn a relationship between the feature vectors and the label data, and output a performance index for each combination of the configuration parameters.

17. The system according to claim 16, wherein the circuitry is configured to select configuration parameters for a subsequent prompt sequence based on the performance index satisfying a predetermined condition, and update content of the subsequent prompt sequence to reflect predicted high-performing combinations of the configuration parameters.

18. A system comprising:
circuitry configured to:
receive attribute data including dimension parameters and configuration parameters from a terminal via a packet-switched network;
generate a prompt sequence based on the attribute data by converting the dimension parameters and the configuration parameters into a natural-language instruction for a generative model;
transmit the prompt sequence to a generative model node via the packet-switched network and receive generated visual data;
transmit the generated visual data to the terminal and monitor interaction event data received from the terminal;
compute a selection metric based on the interaction event data and modify the prompt sequence to preferentially incorporate configuration parameters associated with high selection metric values; and
retransmit the modified prompt sequence to the generative model node to cause regeneration of visual data.

19. The system according to claim 18, wherein the circuitry is configured to cause the generative model node to generate a plurality of items of visual data, compute component-level selection metrics by decomposing each item into constituent component types and aggregating selection events per component type, and update the prompt sequence to preferentially include high-selection-rate components.

20. A method performed by circuitry, the method comprising:
receiving, via a packet-switched network from a terminal, attribute data including dimension parameters and configuration parameters for visual content;
converting the attribute data into a structured generation instruction by mapping the dimension parameters to size constraint values and the configuration parameters to descriptive text segments, and generating, based on the structured generation instruction, a prompt sequence expressed as a natural-language instruction for a generative model;
transmitting the prompt sequence and associated generation parameters as data packets via the packet-switched network to a generative model node;
receiving, from the generative model node, generated visual data corresponding to the prompt sequence, and storing the generated visual data and associated metadata in a storage;
transmitting the generated visual data as data packets via the packet-switched network to the terminal for rendering, and monitoring interaction event data including impression events and selection events received from the terminal; and
computing a selection metric for each item of the generated visual data based on a ratio of the selection events to the impression events, modifying the prompt sequence to preferentially incorporate configuration parameters associated with items of the generated visual data whose selection metric exceeds a predetermined threshold, and retransmitting the modified prompt sequence to the generative model node to cause the generative model node to regenerate visual data.
